(19) United States
(12) Patent Application Publication
(10) Pub. No.: US 2020/0156210 A1
(43) Pub. Date: May 21, 2020

(54) Systems and Methods for Obtaining Real-Time Abrasion Data

(71) Applicants: Saint-Gobain Abrasives, Inc., Worcester, MA (US); Saint-Gobain Abrasifs, Conflans-Sainte-Honorine (FR)

(72) Inventors: Joseph P. Sullivan, Worcester, MA (US); Brahmanandam V. Tanikella, Northborough, MA (US); Christopher Arcona, Northborough, MA (US); Patrick Millot, Lexington, MA (US); Joao Fernando G. Oliveira, Sao Carlos (BR); Rajappa Tadepalli, Northborough, MA (US)

(21) Appl. No.: 16/690,998

(22) Filed: Nov. 21, 2019

Related U.S. Application Data
(60) Provisional application No. 62/887,231, filed on Aug. 15, 2019.
(60) Provisional application No. 62/770,394, filed on Nov. 21, 2018.

(51) Int. Cl. B24B 49/00; H04W 4/80; H04B 1/3827

(52) U.S. Cl. CPC B24B 49/003; B24B 49/006; B24B 23/02; H04B 1/385; H04W 4/80

(57) ABSTRACT

The present application relates to systems and methods for obtaining real-time abrasion data. An example system includes a remote sensor that is located remotely from a grinding tool and a workpiece. The remote sensor is configured to detect vibration and/or noise associated with a grinding operation involving the grinding tool and the workpiece. The system includes communication interface and a controller configured to carry out operations. The operations include receiving, from the remote sensor, at least one of vibration or noise information associated with the grinding tool and the workpiece. The operations also include determining tool-specific information or workpiece-specific information based on the at least one of the vibration or noise information. The operations yet further include transmitting, via the communication interface, the tool-specific information or workpiece-specific information. The system also includes a remote computing device configured to receive the transmitted tool-specific information or workpiece-specific information.

### CROSS-REFERENCE TO RELATED APPLICATIONS

The present application claims priority to U.S. Provisional Patent Application No. 62/770,394, filed on Nov. 21, 2018, the contents of which are entirely incorporated by reference herein. The present application further claims priority to U.S. Provisional Patent Application No. 62/887,231, filed on Aug. 15, 2019, the contents of which are entirely incorporated by reference herein.

### BACKGROUND

Abrasive tools can be used in various material removal operations. Such tools have been equipped with sensors that may monitor the usage of the tools. For example, a power sensor may be incorporated into a tool in order to monitor the electrical power that is consumed by the load. Although a power sensor incorporated into the tool may provide a user of the tool with useful information related to the tool, the sensor may not fully capture the operation of the tool and/or the experience of the user. For example, power sensor data cannot effectively be used to determine whether a component of the tool has been damaged or is malfunctioning.

### SUMMARY

The present disclosure generally relates to systems and methods for obtaining, analyzing, and utilizing real-time data in abrasive and abrasive tool applications.

In a first aspect, a system is provided. The system includes a body-mountable device. The body mountable device includes at least one sensor that is configured to detect abrasive operational data associated with an abrasive operation involving an abrasive product or a workpiece. The body-mountable device also includes a communication interface. The body-mountable device further includes a controller comprising a memory and a processor. The memory stores instructions that are executable by the processor to cause the controller to perform operations. The operations include receiving, from the at least one sensor, the abrasive operational data. The operations also include determining product-specific information of the abrasive product or workpiece-specific information of the workpiece based on the abrasive operational data. The operations further include transmitting, via the communication interface, the product-specific information or workpiece-specific information. The system further includes a remote computing device configured to receive the transmitted product-specific information or workpiece-specific information.

In a second aspect, a method is provided. The method include receiving, from at least one sensor disposed in proximity to an abrasive product or a workpiece, abrasive operational data associated with an abrasive operation involving the abrasive product or the workpiece. The method also includes determining product-specific information or workpiece-specific information based on the abrasive operational data. The method further includes transmitting, to a remote computing device via a communication interface, the product-specific information or the workpiece-specific information.

In a third aspect, a system is provided. The system includes a database containing mappings between: (i) prior abrasive operational data involving a abrasive products and workpieces; and (ii) product-specific information and workpiece specific-information associated with the prior abrasive operational data. The system also includes a computing device configured to perform operations. The operations include receiving, from at least one sensor is configured to detect abrasive operational data, abrasive operational data associated with an abrasive operation involving an abrasive product and a workpiece. The operations further include predicting, using the mappings, that the abrasive operational data relates to product-specific information of the abrasive product or workpiece-specific information of the workpiece.

### BRIEF DESCRIPTION OF THE DRAWINGS

FIG. 1 illustrates a block diagram of a wearable device, according to an example embodiment.

FIG. 2 illustrates a scenario of using a wearable device, according to an example embodiment.

FIG. 3 depicts a table of operational statuses of a wearable device, according to an example embodiment.

FIG. 4 depicts graphs that demonstrate a correlation of a power signal and a vibration signal of an abrasive tool, according to an example embodiment.

FIG. 5 depicts acceleration graphs from which an operation severity of an abrasive tool can be determined, according to an example embodiment.

FIGS. 6A and 6B each depict acceleration graphs from which an unbalanced abrasive article of an abrasive tool can be detected, according to example embodiments.

FIG. 7 depicts acceleration graphs from which a damaged disk of an abrasive tool can be detected, according to example embodiments.

FIG. 8 depicts acceleration graphs from which shocks and/or strokes of an abrasive tool can be detected, according to an example embodiment.

FIG. 9 includes a perspective view illustration of a bonded abrasive article, according to an example embodiment.

FIG. 10A includes a perspective view illustration of a shaped abrasive particle, according to an example embodiment.

FIG. 10B includes a top-down illustration of the shaped abrasive particle of FIG. 10A, according to an example embodiment.

FIG. 11 includes a perspective view illustration of a shaped abrasive particle, according to an example embodiment.

FIG. 12A includes a perspective view illustration of a controlled height abrasive particle (CHAP), according to an example embodiment.

FIG. 12B includes a perspective view illustration of a non-shaped particle, according to an example embodiment.

FIG. 13 includes a cross-sectional illustration of a coated abrasive article incorporating particulate material, according to an example embodiment.

FIG. 14 includes a top view of a portion of a coated abrasive, according to an example embodiment.

FIG. 15 illustrates a cross-sectional of a portion of a coated abrasive, according to an example embodiment.

FIG. 16 illustrates a graph, according to an example embodiment.

FIG. 17 illustrates a graph, according to an example embodiment.

FIG. 18 illustrates a system, according to an example embodiment.

FIG. 19 illustrates a model, according to an example embodiment.

FIG. 20 illustrates a view of a web application, according to an example embodiment.

FIG. 21 illustrates several displays of a wearable device, according to an example embodiment.

FIG. 22 illustrates an example wearable device, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

In line with the discussion above, sensors (e.g., power sensors) that are incorporated into an abrasive tool (e.g., a grinding tool) do not adequately capture the behavior of the tool or the user experience of the operator using the tool. Thus, although such sensors may provide the operator with some information about the operation of the tool, the sensors cannot provide the operator with other information or insights, such as real-time values of abrasive tool parameters and/or real-time feedback of abrasive operations performed using the tool.

Disclosed herein are methods and systems for determining and using abrasive operational data indicative of a behavior of an abrasive tool. As described herein, the abrasive operational data could be used for many purposes including capturing a behavior of an abrasive tool, capturing a user experience of an operator using the tool, and/or determining operational and/or enterprise improvements (e.g., workflow best practices).

As used herein, the term abrasive tool includes any tool configured to be used with an abrasive article. An abrasive article can include a fixed abrasive article including at least a substrate and abrasive particles connected to (e.g., contained within or overlying) the substrate. The abrasive articles of the embodiments herein can be bonded abrasives, coated abrasive, non-woven abrasives, thin wheels, cut-off wheels, reinforced abrasive articles, superabrasives, single-layered abrasive articles and the like. Such abrasive articles can include one or more various types of abrasive particles, including for example, but not limited to, shaped abrasive particles, constant height abrasive particles, unshaped abrasive particles (e.g., crushed or exploded abrasive particles) and the like.

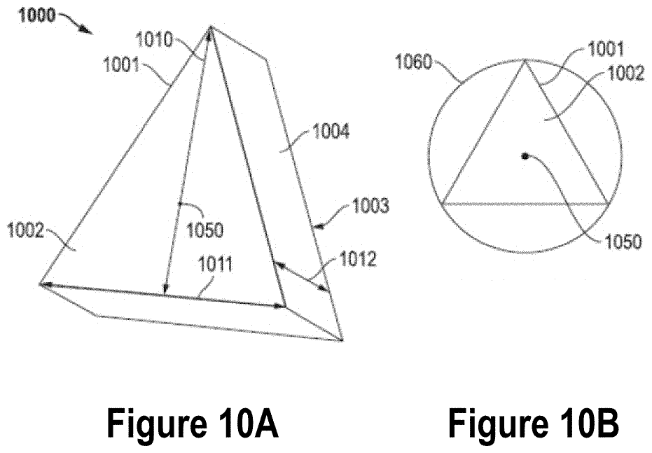

FIG. 10A includes a perspective view illustration of a shaped abrasive particle in accordance with an embodiment. The shaped abrasive particle 1000 can include a body 1001 including a major surface 1002, a major surface 1003, and a side surface 1004 extending between the major surfaces 1002 and 1003. As illustrated in FIG. 10A, the body 1001 of the shaped abrasive particle 1000 can be a thin-shaped body, wherein the major surfaces 1002 and 1003 are larger than the side surface 1004. Moreover, the body 1001 can include a longitudinal axis 1010 extending from a point to a base and through the midpoint 1050 on a major surface 1002 or 1003. The longitudinal axis 1010 can define the longest dimension of the body along a major surface and through the midpoint 1050 of the major surface 1002.

In certain particles, if the midpoint of a major surface of the body is not readily apparent, one may view the major surface top-down, draw a closest-fit circle around the two-dimensional shape of the major surface and use the center of the circle as the midpoint of the major surface.

FIG. 10B includes a top-down illustration of the shaped abrasive particle of FIG. 10A. Notably, the body 1001 includes a major surface 1002 having a triangular two-dimensional shape. The circle 1060 is drawn around the triangular shape to facilitate location of the midpoint 1050 on the major surface 1002.

Referring again to FIG. 10A, the body 1001 can further include a lateral axis 1011 defining a width of the body 1001 extending generally perpendicular to the longitudinal axis 1010 on the same major surface 1002. Finally, as illustrated, the body 1001 can include a vertical axis 1012, which in the context of thin shaped bodies can define a height (or thickness) of the body 1001. For thin-shaped bodies, the length of the longitudinal axis 1010 is greater than the vertical axis 1012. As illustrated, the thickness along the vertical axis 1012 can extend along the side surface 1004 between the major surfaces 1002 and 1003 and perpendicular to the plane defined by the longitudinal axis 1010 and lateral axis 1011. It will be appreciated that reference herein to length, width, and height of the abrasive particles may be reference to average values taken from a suitable sampling size of abrasive particles of a larger group, including for example, a group of abrasive particle affixed to a fixed abrasive.

The shaped abrasive particles of the embodiments herein, including thin shaped abrasive particles can have a primary aspect ratio of length:width such that the length can be greater than or equal to the width. Furthermore, the length of the body 1001 can be greater than or equal to the height. Finally, the width of the body 1001 can be greater than or equal to the height. In accordance with an embodiment, the primary aspect ratio of length:width can be at least 1:1, such as at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 1001 of the shaped abrasive particle can have a primary aspect ratio of length:width of not greater than 100:1, not greater than 50:1, not greater than 10:1, not greater than 6:1, not greater than 5:1, not greater than 4:1, not greater than 3:1, not greater than 2:1, or even not greater than 1:1. It will be appreciated that the primary aspect ratio of the body 1001 can be within a range including any of the minimum and maximum ratios noted above.

However, in certain other embodiments, the width can be greater than the length. For example, in those embodiments wherein the body 1001 is an equilateral triangle, the width can be greater than the length. In such embodiments, the primary aspect ratio of length:width can be at least 1:1.1 or at least 1:1.2 or at least 1:1.3 or at least 1:1.5 or at least 1:1.8 or at least 1:2 or at least 1:2.5 or at least 1:3 or at least 1:4 or at least 1:5 or at least 1:10. Still, in a non-limiting embodiment, the primary aspect ratio length:width can be not greater than 1:100 or not greater than 1:50 or not greater than 1:25 or not greater than 1:10 or not greater than 5:1 or not greater than 3:1. It will be appreciated that the primary aspect ratio of the body 1001 can be within a range including any of the minimum and maximum ratios noted above.

Furthermore, the body 1001 can have a secondary aspect ratio of width:height that can be at least 1:1, such as at least 1.1:1, at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio width:height of the body 1001 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the secondary aspect ratio of width:height can be within a range including any of the minimum and maximum ratios of above.

In another embodiment, the body 1001 can have a tertiary aspect ratio of length:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio length:height of the body 1001 can be not greater than 100:1, such as not greater than 50:1, not greater than 10:1, not greater than 8:1, not greater than 6:1, not greater than 5:1, not greater than 4:1, not greater than 3:1. It will be appreciated that the tertiary aspect ratio the body 1001 can be within a range including any of the minimum and maximum ratios and above.

The abrasive particles of the embodiments herein, including the shaped abrasive particles can include a crystalline material, and more particularly, a polycrystalline material. Notably, the polycrystalline material can include abrasive grains. In one embodiment, the body of the abrasive particle, including for example, the body of a shaped abrasive particle can be essentially free of an organic material, such as, a binder. In at least one embodiment, the abrasive particles can consist essentially of a polycrystalline material. In another embodiment, the abrasive particles, such as shaped abrasive particles can be free of silane, and particularly, may not have a silane coating.

The abrasive particles may be made of certain material, including but not limited to nitrides, oxides, carbides, borides, oxynitrides, oxyborides, diamond, carbon-containing materials, and a combination thereof. In particular instances, the abrasive particles can include an oxide compound or complex, such as aluminum oxide, zirconium oxide, titanium oxide, yttrium oxide, chromium oxide, strontium oxide, silicon oxide, magnesium oxide, rare-earth oxides, and a combination thereof. The abrasive particles may be superabrasive particles.

In one particular embodiment, the abrasive particles can include a majority content of alumina. For at least one embodiment, the abrasive particle can include at least 80 wt % alumina, such as at least 90 wt % alumina, at least 91 wt % alumina, at least 92 wt % alumina, at least 93 wt % alumina, at least 94 wt % alumina, at least 95 wt % alumina, at least 96 wt % alumina, or even at least 97 wt % alumina. Still, in at least one particular embodiment, the abrasive particle can include not greater than 99.5 wt % alumina, such as not greater than 99 wt % alumina, not greater than 98.5 wt % alumina, not greater than 97.5 wt % alumina, not greater than 97 wt % alumina not greater than 96 wt % alumina, or even not greater than 94 wt % alumina. It will be appreciated that the abrasive particles of the embodiments herein can include a content of alumina within a range including any of the minimum and maximum percentages noted above. Moreover, in particular instances, the shaped abrasive particles can be formed from a seeded sol-gel. In at least one embodiment, the abrasive particles can consist essentially of alumina and certain dopant materials as described herein.

The abrasive particles of the embodiments herein can include particularly dense bodies, which may be suitable for use as abrasives. For example, the abrasive particles may have a body having a density of at least 95% theoretical density, such as at least 96% theoretical density, at least 97% theoretical density, at least 98% theoretical density or even at least 99% theoretical density.

The abrasive grains (i.e., crystallites) contained within the body of the abrasive particles may have an average grain size (i.e., average crystal size) that is generally not greater than about 100 microns. In other embodiments, the average grain size can be less, such as not greater than about 80 microns or not greater than about 50 microns or not greater than about 30 microns or not greater than about 20 microns or not greater than about 10 microns or not greater than 6 microns or not greater than 5 microns or not greater than 4 microns or not greater than 3.5 microns or not greater than 3 microns or not greater than 2.5 microns or not greater than 2 microns or not greater than 1.5 microns or not greater than 1 micron or not greater than 0.8 microns or not greater than 0.6 microns or not greater than 0.5 microns or not greater than 0.4 microns or not greater than 0.3 microns or even not greater than 0.2 microns. Still, the average grain size of the abrasive grains contained within the body of the abrasive particle can be at least about 0.01 microns, such as at least about 0.05 microns or at least about 0.06 microns or at least about 0.07 microns or at least about 0.08 microns or at least about 0.09 microns or at least about 0.1 microns or at least about 0.12 microns or at least about 0.15 microns or at least about 0.17 microns or at least about 0.2 microns or even at least about 0.3 microns. It will be appreciated that the abrasive particles can have an average grain size (i.e., average crystal size) within a range between any of the minimum and maximum values noted above.

The average grain size (i.e., average crystal size) can be measured based on the uncorrected intercept method using scanning electron microscope (SEM) photomicrographs. Samples of abrasive grains are prepared by making a bakelite mount in epoxy resin then polished with diamond polishing slurry using a Struers Tegramin 30 polishing unit. After polishing the epoxy is heated on a hot plate, the polished surface is then thermally etched for 5 minutes at 150° C. below sintering temperature. Individual grains (5-10 grits) are mounted on the SEM mount then gold coated for SEM preparation. SEM photomicrographs of three individual abrasive particles are taken at approximately 50,000× magnification, then the uncorrected crystallite size is calculated using the following steps: 1) draw diagonal lines from one corner to the opposite corner of the crystal structure view, excluding black data band at bottom of photo 2) measure the length of the diagonal lines as L1 and L2 to the nearest 0.1 centimeters; 3) count the number of grain boundaries intersected by each of the diagonal lines, (i.e., grain boundary intersections I1 and I2) and record this number for each of the diagonal lines, 4) determine a calculated bar number by measuring the length (in centimeters) of the micron bar (i.e., “bar length”) at the bottom of each photomicrograph or view screen, and divide the bar length (in microns) by the bar length (in centimeters); 5) add the total centimeters of the diagonal lines drawn on photomicrograph (L1+L2) to obtain a sum of the diagonal lengths; 6) add the numbers of grain boundary intersections for both diagonal lines (I1+I2) to obtain a sum of the grain boundary intersections; 7) divide the sum of the diagonal lengths (L1+L2) in centimeters by the sum of grain boundary intersections (I1+I2) and multiply this number by the calculated bar number. This process is completed at least three different times for three different, randomly selected samples to obtain an average crystallite size.

In accordance with certain embodiments, certain abrasive particles can be composite articles including at least two different types of grains within the body of the abrasive particle. It will be appreciated that different types of grains are grains having different compositions with regard to each other. For example, the body of the abrasive particle can be formed such that is includes at least two different types of grains, wherein the two different types of grains can be nitrides, oxides, carbides, borides, oxynitrides, oxyborides, diamond, and a combination thereof.

In accordance with an embodiment, the abrasive particles can have an average particle size, as measured by the largest dimension (i.e., length) of at least about 100 microns. In fact, the abrasive particles can have an average particle size of at least about 150 microns, such as at least about 200 microns, at least about 300 microns, at least about 400 microns, at least about 500 microns, at least about 600 microns, at least about microns, at least about 800 microns, or even at least about 900 microns. Still, the abrasive particles of the embodiments herein can have an average particle size that is not greater than about 5 mm, such as not greater than about 3 mm, not greater than about 2 mm, or even not greater than about 1.5 mm. It will be appreciated that the abrasive particles can have an average particle size within a range between any of the minimum and maximum values noted above.

FIG. 10 includes an illustration of a shaped abrasive particle having a two-dimensional shape as defined by the plane of the upper major surface 1002 or major surface 1003, which has a generally triangular two-dimensional shape. It will be appreciated that the shaped abrasive particles of the embodiments herein are not so limited and can include other two-dimensional shapes. For example, the shaped abrasive particles of the embodiment herein can include particles having a body with a two-dimensional shape as defined by a major surface of the body from the group of shapes including polygons, regular polygons, irregular polygons, irregular polygons including arcuate or curved sides or portions of sides, ellipsoids, numerals, Greek alphabet characters, Latin alphabet characters, Russian alphabet characters, Kanji characters, complex shapes having a combination of polygons shapes, shapes including a central region and a plurality of arms (e.g., at least three arms) extending from a central region (e.g., star shapes), and a combination thereof. Particular polygonal shapes include rectangular, trapezoidal, quadrilateral, pentagonal, hexagonal, heptagonal, octagonal, nonagonal, decagonal, and any combination thereof. In another instance, the finally-formed shaped abrasive particles can have a body having a two-dimensional shape such as an irregular quadrilateral, an irregular rectangle, an irregular trapezoid, an irregular pentagon, an irregular hexagon, an irregular heptagon, an irregular octagon, an irregular nonagon, an irregular decagon, and a combination thereof. An irregular polygonal shape is one where at least one of the sides defining the polygonal shape is different in dimension (e.g., length) with respect to another side. As illustrated in other embodiments herein, the two-dimensional shape of certain shaped abrasive particles can have a particular number of exterior points or external corners. For example, the body of the shaped abrasive particles can have a two-dimensional polygonal shape as viewed in a plane defined by a length and width, wherein the body comprises a two-dimensional shape having at least 4 exterior points (e.g., a quadrilateral), at least 5 exterior points (e.g., a pentagon), at least 6 exterior points (e.g., a hexagon), at least 7 exterior points (e.g., a heptagon), at least 8 exterior points (e.g., an octagon), at least 9 exterior points (e.g., a nonagon), and the like.

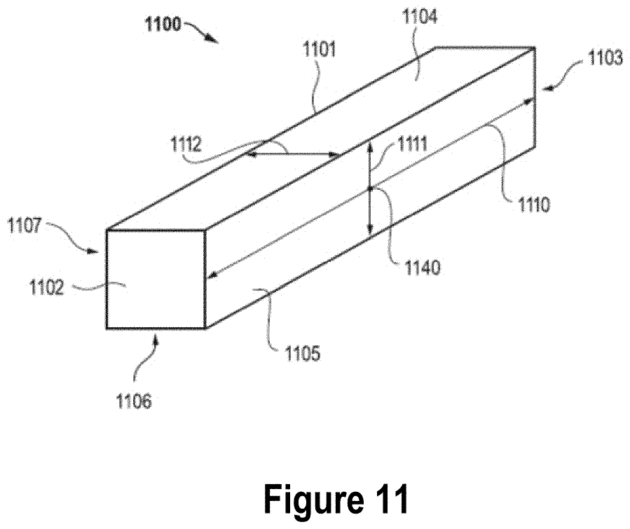

FIG. 11 includes a perspective view illustration of a shaped abrasive particle according to another embodiment. Notably, the shaped abrasive particle 1100 can include a body 1101 including a surface 1102 and a surface 1103, which may be referred to as end surfaces 1102 and 1103. The body can further include major surfaces 1104, 1105, 1106, 1107 extending between and coupled to the end surfaces 1102 and 1103. The shaped abrasive particle of FIG. 11 is an elongated shaped abrasive particle having a longitudinal axis 1110 that extends along the major surface 1105 and through the midpoint 1140 between the end surfaces 1102 and 1103. For particles having an identifiable two-dimensional shape, such as the shaped abrasive particles of FIGS. 10 and 11, the longitudinal axis is the dimension that would be readily understood to define the length of the body through the midpoint on a major surface. For example, in FIG. 11, the longitudinal axis 1110 of the shaped abrasive particle 1100 extends between the end surfaces 1102 and 1103 parallel to the edges defining the major surface as shown. Such a longitudinal axis is consistent with how one would define the length of a rod. Notably, the longitudinal axis 1110 does not extend diagonally between the corners joining the end surfaces 1102 and 1103 and the edges defining the major surface 1105, even though such a line may define the dimension of greatest length. To the extent that a major surface has undulations or minor imperfections from a perfectly planar surface, the longitudinal axis can be determined using a top-down, two-dimensional image that ignores the undulations.

It will be appreciated that the surface 1105 is selected for illustrating the longitudinal axis 1110, because the body 1101 has a generally square cross-sectional contour as defined by the end surfaces 1102 and 1103. As such, the surfaces 1104, 1105, 1106, and 17 can be approximately the same size relative to each other. However, in the context of other elongated abrasive particles, the surfaces 1102 and 1103 can have a different shape, for example, a rectangular shape, and as such, at least one of the surfaces 1104, 1105, 1106, and 1107 may be larger relative to the others. In such instances, the largest surface can define the major surface and the longitudinal axis would extend along the largest of those surfaces through the midpoint 1140 and may extend parallel to the edges defining the major surface. As further illustrated, the body 1101 can include a lateral axis 1111 extending perpendicular to the longitudinal axis 1110 within the same plane defined by the surface 1105. As further illustrated, the body 1101 can further include a vertical axis 1112 defining a height of the abrasive particle, were in the vertical axis 1112 extends in a direction perpendicular to the plane defined by the longitudinal axis 1110 and lateral axis 1111 of the surface 1105.

It will be appreciated that like the thin shaped abrasive particle of FIG. 10, the elongated shaped abrasive particle of FIG. 11 can have various two-dimensional shapes, such as those defined with respect to the shaped abrasive particle of FIG. 10. The two-dimensional shape of the body 1101 can be defined by the shape of the perimeter of the end surfaces 1102 and 1103. The elongated shaped abrasive particle 1100 can have any of the attributes of the shaped abrasive particles of the embodiments herein.

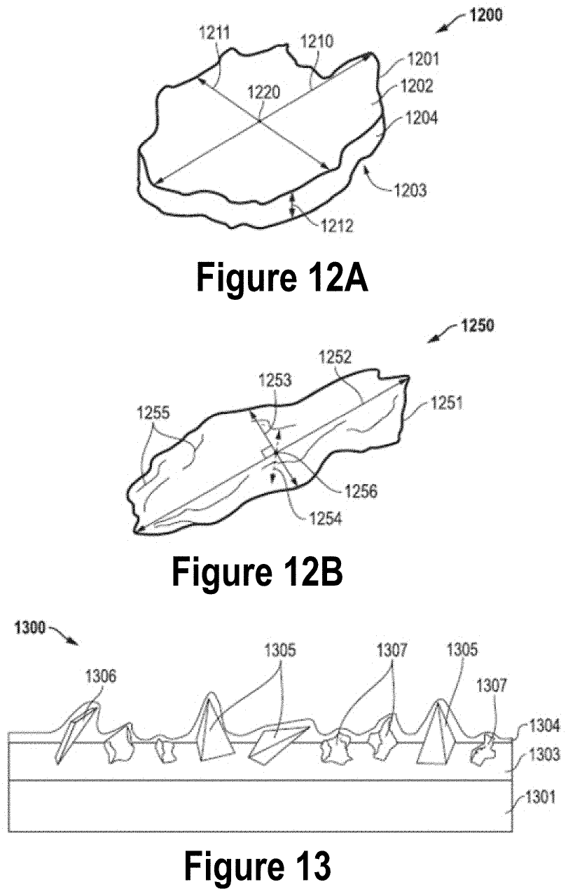

FIG. 12A includes a perspective view illustration of a controlled height abrasive particle according (CHAP) to an embodiment. As illustrated, the CHAP 1200 can include a body 1201 including a first major surface 1202, a second major surface 1203, and a side surface 1204 extending between the first and second major surfaces 1202 and 1203. As illustrated in FIG. 12A, the body 1201 can have a thin, relatively planar shape, wherein the first and second major surfaces 1202 and 1203 are larger than the side surface 1204 and substantially parallel to each other. Moreover, the body 1201 can include a longitudinal axis 1210 extending through the midpoint 1220 and defining a length of the body 1201. The body 1201 can further include a lateral axis 1211 on the first major surface 1202, which extends through the midpoint 1220 of the first major surface 1202, perpendicular to the longitudinal axis 1210, and defining a width of the body 1201.

The body 1201 can further include a vertical axis 1212, which can define a height (or thickness) of the body 1201. As illustrated, the vertical axis 1212 can extend along the side surface 1204 between the first and second major surfaces 1202 and 1203 in a direction generally perpendicular to the plane defined by the axes 1210 and 1211 on the first major surface. For thin-shaped bodies, such as the CHAP illustrated in FIG. 12A, the length can be equal to or greater than the width and the length can be greater than the height. It will be appreciated that reference herein to length, width, and height of the abrasive particles may be referenced to average values taken from a suitable sampling size of abrasive particles of a batch of abrasive particles.

Unlike the shaped abrasive particles of FIGS. 10A, 10B, and 11, the CHAP of FIG. 12A does not have a readily identifiable two-dimensional shape based on the perimeter of the first or second major surfaces 1202 and 1203. Such abrasive particles may be formed in a variety of ways, including but not limited to, fracturing of a thin layer of material to form abrasive particles having a controlled height but with irregularly formed, planar, major surfaces. For such particles, the longitudinal axis is defined as the longest dimension on the major surface that extends through a midpoint on the surface. To the extent that the major surface has undulations, the longitudinal axis can be determined using a top-down, two-dimensional image that ignores the undulations. Moreover, as noted above in FIG. 10B, a closest-fit circle may be used to identify the midpoint of the major surface and identification of the longitudinal and lateral axes.

FIG. 12B includes an illustration of a non-shaped particle, which may be an elongated, non-shaped abrasive particle or a secondary particle, such as a diluent grain, a filler, an agglomerate or the like. Shaped abrasive particles may be formed through particular processes, including molding, printing, casting, extrusion, and the like. Shaped abrasive particles can be formed such that the each particle has substantially the same arrangement of surfaces and edges relative to each other. For example, a group of shaped abrasive particles generally have the same arrangement and orientation and or two-dimensional shape of the surfaces and edges relative to each other. As such, the shaped abrasive particles have a relatively high shape fidelity and consistency in the arrangement of the surfaces and edges relative to each other. Moreover, constant height abrasive particles (CHAPs) can also be formed through particular processes that facilitate formation of thin-shaped bodies that can have irregular two-dimensional shapes when viewing the major surface top-down. CHAPs can have less shape fidelity than shaped abrasive particles, but can have substantially planar and parallel major surfaces separated by a side surface.

By contrast, non-shaped particles can be formed through different processes and have different shape attributes compared to shaped abrasive particles and CHAPs. For example, non-shaped particles are typically formed by a comminution process wherein a mass of material is formed and then crushed and sieved to obtain abrasive particles of a certain size. However, a non-shaped particle will have a generally random arrangement of surfaces and edges, and generally will lack any recognizable two-dimensional or three dimensional shape in the arrangement of the surfaces and edges. Moreover, non-shaped particles do not necessarily have a consistent shape with respect to each other, and therefore have a significantly lower shape fidelity compared to shaped abrasive particles or CHAPs. The non-shaped particles generally are defined by a random arrangement of surfaces and edges for each particle and with respect to other non-shaped particles

FIG. 12B includes a perspective view illustration of a non-shaped particle. The non-shaped particle 1250 can have a body 1251 including a generally random arrangement of edges 1255 extending along the exterior surface of the body 1251. The body can further include a longitudinal axis 1252 defining the longest dimension of the particle. The longitudinal axis 1252 defines the longest dimension of the body as viewed in two-dimensions. Thus, unlike shaped abrasive particles and CHAPs, where the longitudinal axis is measured on the major surface, the longitudinal axis of a non-shaped particle is defined by the points on the body furthest from each other as the particle is viewed in two-dimensions using an image or vantage that provides a view of the particle's longest dimension. That is, an elongated particle, but non-shaped particles, such as illustrated in FIG. 12B, should be viewed in a perspective that makes the longest dimension apparent to properly evaluate the longitudinal axis. The body 1251 can further include a lateral axis 1253 extending perpendicular to the longitudinal axis 1252 and defining a width of the particle. The lateral axis 1253 can extend perpendicular to the longitudinal axis 1252 through the midpoint 1256 of the longitudinal axis in the same plane used to identify the longitudinal axis 1252. The abrasive particle may have a height (or thickness) as defined by the vertical axis 1254. The vertical axis 1254 can extend through the midpoint 1256 but in a direction perpendicular to the plane used to define the longitudinal axis 1252 and lateral axis 1253. To evaluate the height, one may have to change the perspective of view of the abrasive particle to look at the particle from a different vantage than is used to evaluate the length and width.

As will be appreciated, the abrasive particle can have a length defined by the longitudinal axis 1252, a width defined by the lateral axis 1253, and a vertical axis 1254 defining a height. As will be appreciated, the body 1251 can have a primary aspect ratio of length:width such that the length is equal to or greater than the width. Furthermore, the length of the body 1251 can be equal to or greater than or equal to the height. Finally, the width of the body 1251 can be greater than or equal to the height. In accordance with an embodiment, the primary aspect ratio of length:width can be at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 1251 of the elongated shaped abrasive particle can have a primary aspect ratio of length:width of not greater than 100:1, not greater than 50:1, not greater than 10:1, not greater than 6:1, not greater than 5:1, not greater than 4:1, not greater than 3:1, or even not greater than 2:1. It will be appreciated that the primary aspect ratio of the body 1251 can be within a range including any of the minimum and maximum ratios noted above.

Furthermore, the body 1251 can include a secondary aspect ratio of width:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio width:height of the body 1251 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the secondary aspect ratio of width:height can be with a range including any of the minimum and maximum ratios of above.

In another embodiment, the body 1251 can have a tertiary aspect ratio of length:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio length:height of the body 1251 can be not greater than 100:1, such as not greater than 50:1, not greater than 10:1, not greater than 8:1, not greater than 6:1, not greater than 5:1, not greater than 4:1, not greater than 3:1, It will be appreciated that the tertiary aspect ratio the body 1251 can be with a range including any of the minimum and maximum ratios and above.

The non-shaped particle 1250 can have any of the attributes of abrasive particles described in the embodiments herein, including for example but not limited to, composition, microstructural features (e.g., average grain size), hardness, porosity, and the like.

The abrasive articles of the embodiments herein may incorporate different types of particles, including different types of abrasive particles, different types of secondary particles, or any combination thereof. For example, in one embodiment, the coated abrasive article can include a first type of abrasive particle comprising shaped abrasive particles and a second type of abrasive particle. The second type of abrasive particle may be a shaped abrasive particle or a non-shaped abrasive particle.

FIG. 13 includes a cross-sectional illustration of a coated abrasive article incorporating particulate material in accordance with an embodiment. As illustrated, the coated abrasive 1300 can include a substrate 1301 and a make coat 1303 overlying a surface of the substrate 1301. The coated abrasive 1300 can further include a first type of particulate material 1305 in the form of a first type of shaped abrasive particle, a second type of particulate material 1306 in the form of a second type of shaped abrasive particle, and a third type of particulate material 1307, which may be a secondary particle, such as a diluent abrasive particle, a non-shaped abrasive particle, a filler, and the like. The coated abrasive 1300 may further include size coat 1304 overlying and bonded to the abrasive particulate materials 1305, 1306, 1307, and the size coat 1304. It will be appreciated that other layers or materials may be added to the substrate other component layers, including for example, but not limited to, a frontfill, a backfill, and the like as known to those of ordinary skill in the art.

According to one embodiment, the substrate 1301 can include an organic material, inorganic material, and a combination thereof. In certain instances, the substrate 1301 can include a woven material. However, the substrate 1301 may be made of a non-woven material. Particularly suitable substrate materials can include organic materials, including polymers, and particularly, polyester, polyurethane, polypropylene, polyimides such as KAPTON from DuPont, paper or any combination thereof. Some suitable inorganic materials can include metals, metal alloys, and particularly, foils of copper, aluminum, steel, and a combination thereof. In the context of a non-woven substrate, which may be open web of fibers, the abrasive particles may be adhered to the fibers by one or more adhesive layers. In such non-woven products, the abrasive particles are coating the fibers, but not necessarily forming a conformal layer overlying a major surface of the substrate as illustrated in FIG. 13. It will be appreciated that such non-woven products are included in the embodiments herein.

The make coat 1303 can be applied to the surface of the substrate 1301 in a single process, or alternatively, the particulate materials 1305, 1306, 1307 can be combined with a make coat 1303 material and the combination of the make coat 1303 and particulate materials 1305-1307 can be applied as a mixture to the surface of the substrate 1301. In certain instances, controlled deposition or placement of the particles 1305-1307 in the make coat may be better suited by separating the processes of applying the make coat 1303 from the deposition of the abrasive particulate materials 1305-1307 in the make coat 1303. Still, it is contemplated that such processes may be combined. Suitable materials of the make coat 1303 can include organic materials, particularly polymeric materials, including for example, polyesters, epoxy resins, polyurethanes, polyamides, polyacrylates, polymethacrylates, polyvinylchlorides, polyethylene, polysiloxane, silicones, cellulose acetates, nitrocellulose, natural rubber, starch, shellac, and mixtures thereof. In one embodiment, the make coat 1303 can include a polyester resin. The coated substrate can then be heated in order to cure the resin and the abrasive particulate material to the substrate. In general, the coated substrate 1301 can be heated to a temperature of between about 100° C. to less than about 250° C. during this curing process.

The particulate materials 1305-1307 can include different types of abrasive particles according to embodiments herein. The different types of abrasive particles can include different types of shaped abrasive particles, different types of secondary particles or a combination thereof. The different types of particles can be different from each other in composition, two-dimensional shape, three-dimensional shape, grain size, particle size, hardness, friability, agglomeration, and a combination thereof. As illustrated, the coated abrasive 1300 can include a first type of shaped abrasive particle 1305 having a generally pyramidal shape and a second type of shaped abrasive particle 1306 having a generally triangular two-dimensional shape. The coated abrasive 1300 can include different amounts of the first type and second type of shaped abrasive particles 1305 and 1306. It will be appreciated that the coated abrasive may not necessarily include different types of shaped abrasive particles, and can consist essentially of a single type of shaped abrasive particle. As will be appreciated, the shaped abrasive particles of the embodiments herein can be incorporated into various fixed abrasives (e.g., bonded abrasives, coated abrasive, non-woven abrasives, thin wheels, cut-off wheels, reinforced abrasive articles, and the like), including in the form of blends, which may include different types of shaped abrasive particles, secondary particles, and the like.

The particles 1307 can be secondary particles different than the first and second types of shaped abrasive particles 1305 and 1306. For example, the secondary particles 1307 can include crushed abrasive grit representing non-shaped abrasive particles.

After sufficiently forming the make coat 1303 with the abrasive particulate materials 1305-1307 contained therein, the size coat 1304 can be formed to overlie and bond the abrasive particulate material 1305 in place. The size coat 1304 can include an organic material, may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof.

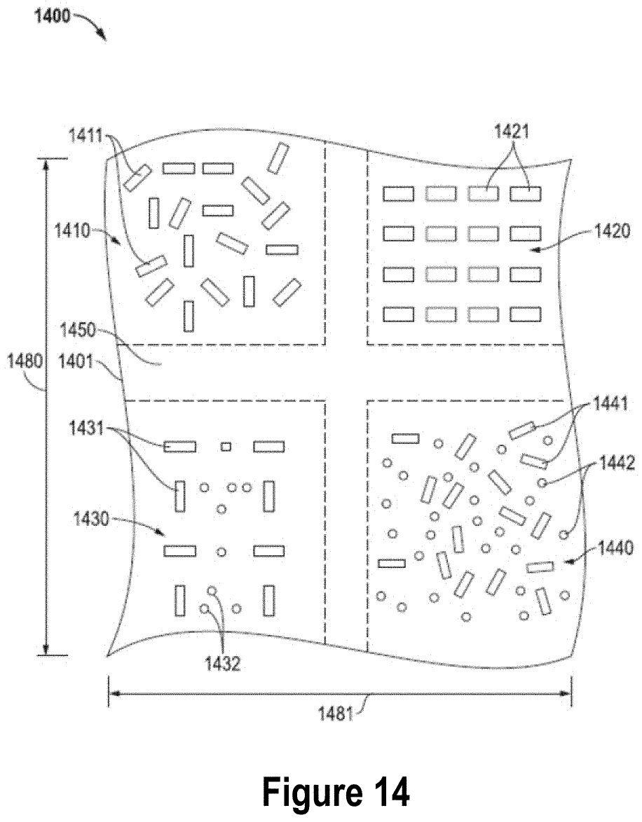

FIG. 14 includes a top view of a portion of a coated abrasive according to an embodiment. The coated abrasive article 1400 can include a plurality of regions, such as a first region 1410, a second region 1420, a third region 1430 and a fourth region 1440. Each of the regions 1410, 1420, 1430, and 1440 can be separated by a channel region 1450, wherein the channel region 1450 defines a region the backing that is free of particles. The channel region 1450 can have any size and shape and may be particularly useful for removing swarf and improved grinding operations. The channel region may have a length (i.e., longest dimension) and width (i.e., shortest dimension perpendicular to the length) that is greater than the average spacing between immediately adjacent abrasive particles within any of the regions 1410, 1420, 1430, and 1440. The channel region 1450 is an optional feature for any of the embodiments herein.

As further illustrated, the first region 1410 can include a group of shaped abrasive particles 1411 having a generally random rotational orientation with respect to each other. The group of shaped abrasive particles 1411 can be arranged in a random distribution relative to each other, such that there is no discernable short-range or long-range order with regard to the placement of the shaped abrasive particles 1411. Notably, the group of shaped abrasive particles 1411 can be substantially homogenously distributed within the first region 1410, such that the formation of clumps (two or more particles in contact with each other) is limited. It will be appreciated that the grain weight of the group of shaped abrasive particles 1411 in the first region 1410 can be controlled based on the intended application of the coated abrasive.

The second region 1420 can include a group of shaped abrasive particles 1421 arranged in a controlled distribution relative to each other. Moreover, the group of shaped abrasive particles 1421 can have a regular and controlled rotational orientation relative to each other. As illustrated, the group of shaped abrasive particles 1421 can have generally the same rotational orientation as defined by the same rotational angle on the backing of the coated abrasive 1401. Notably, the group of shaped abrasive particles 1421 can be substantially homogenously distributed within the second region 1420, such that the formation of clumps (two or more particles in contact with each other) is limited. It will be appreciated that the grain weight of the group of shaped abrasive particles 1421 in the second region 1420 can be controlled based on the intended application of the coated abrasive.

The third region 1430 can include a plurality of groups of shaped abrasive particles 1421 and secondary particles 1432. The group of shaped abrasive particles 1431 and secondary particles 1432 can be arranged in a controlled distribution relative to each other. Moreover, the group of shaped abrasive particles 1431 can have a regular and controlled rotational orientation relative to each other. As illustrated, the group of shaped abrasive particles 1431 can have generally one of two types of rotational orientations on the backing of the coated abrasive 1401. Notably, the group of shaped abrasive particles 1431 and secondary particles 1432 can be substantially homogenously distributed within the third region 1430, such that the formation of clumps (two or more particles in contact with each other) is limited. It will be appreciated that the grain weight of the group of shaped abrasive particles 1431 and secondary particles 1432 in the third region 1430 can be controlled based on the intended application of the coated abrasive.

The fourth region 1440 can include a group of shaped abrasive particles 1441 and secondary particles 1442 having a generally random distribution with respect to each other. Additionally, the group of shaped abrasive particles 1441 can have a random rotational orientation with respect to each other. The group of shaped abrasive particles 1441 and secondary particles 1442 can be arranged in a random distribution relative to each other, such that there is no discernable short-range or long-range order. Notably, the group of shaped abrasive particles 1441 and the secondary particles 1442 can be substantially homogenously distributed within the fourth region 1440, such that the formation of clumps (two or more particles in contact with each other) is limited. It will be appreciated that the grain weight of the group of shaped abrasive particles 1441 and secondary particles 1442 in the fourth region 1440 can be controlled based on the intended application of the coated abrasive.

As illustrated in FIG. 14, the coated abrasive article 1400 can include different regions 1410, 1420, 1430, and 1440, each of which can include different groups of particles, such as shaped particles and secondary particles. The coated abrasive article 1400 is intended to illustrate the different types of groupings, arrangements and distributions of particles that may be created using the systems and processes of the embodiments herein. The illustration is not intended to be limited to only those groupings of particles and it will be appreciated that coated abrasive articles can be made including only one region as illustrated in FIG. 14. It will also be understood that other coated abrasive articles can be made including a different combination or arrangement of one or more of the regions illustrated in FIG. 14.

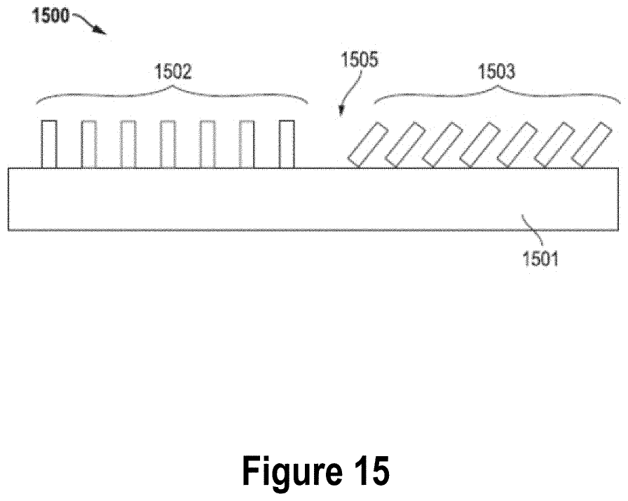

According to another embodiment, a coated abrasive article may be formed that includes different groups of abrasive particles, wherein the different groups have different tilt angles with respect to each other. For example, as illustrated in FIG. 15, a cross-sectional illustration of a portion of a coated abrasive is provided. The coated abrasive 1500 can include a backing 1501 and a first group of abrasive particles 1502, wherein each of the abrasive particles in the first group of abrasive particles 1502 have a first average tilt angle. The coated abrasive 1500 can further include a second group of abrasive particles 1503, wherein each of the abrasive particles in the second group of abrasive particles 1503 have a second average tilt angle. According to one embodiment the first group of abrasive particles 1502 and the second group of abrasive particles 1503 can be separated by a channel region 1505. Moreover, the first average tilt angle can be different than the second average tilt angle. In a more particular embodiment, the first group of abrasive particles may be oriented in an upright orientation and the second group of abrasive particles may be oriented in a slanted orientation. Without wishing to be tied to a particular theory, it is thought that controlled variation of the tilt angle for different groups of abrasive particles in different regions of the coated abrasive may facilitate improved performance of the coated abrasive.

According to one particular aspect, the content of abrasive particles overlying the backing can be controlled based on the intended application. For example, the abrasive particles can be overlying at least 5% of the total surface area of the backing, such as at least 10% or at least 20% or at least 30% or at least 40% or at least 50% or at least 60% or at least 70% or at least 80% or at least 90%. In still another embodiment, the coated abrasive article may be essentially free of silane.

Furthermore, the abrasive articles of the embodiments herein can have a particular content of particles overlying the substrate. Moreover, it is noted that for certain contents of particles on the backing, such as open coat densities, the industry has found it challenging to obtain certain contents of particles in desired vertical orientations. In one embodiment, the particles can define an open coat abrasive product having a coating density of particles (i.e., abrasive particles, secondary particles, or both abrasive particles and secondary particles) of not greater than about 70 particles/cm². In other instances, the density of shaped abrasive particle per square centimeter of the abrasive article may be not greater than about 65 particles/cm², such as not greater than about 60 particles/cm², not greater than about 55 particles/cm², or even not greater than about 50 particles/cm². Still, in one non-limiting embodiment, the density of the open coat coated abrasive using the shaped abrasive particle herein can be at least about 5 particles/cm², or even at least about 10 particles/cm². It will be appreciated that the density of shaped abrasive particles per square centimeter of abrasive article can be within a range between any of the above minimum and maximum values.

In certain instances, the abrasive article can have an open coat density of not greater than about 50% of particles (i.e., abrasive particles or secondary particles or the total of abrasive particles and secondary particles) covering the exterior abrasive surface of the article. In other embodiments, the area of the abrasive particles relative to the total area of the surface on which the particles are placed can be not greater than about 40%, such as not greater than about 30%, not greater than about 25%, or even not greater than about 20%. Still, in one non-limiting embodiment, the percentage coating of the particles relative to the total area of the surface can be at least about 5%, such as at least about 10%, at least about 15%, at least about 20%, at least about 25%, at least about 30%, at least about 35%, or even at least about 40%. It will be appreciated that the percent coverage of the particles for the total area of abrasive surface can be within a range between any of the above minimum and maximum values.

Some abrasive articles may have a particular content of particles (i.e., abrasive particles or secondary particles or the total of abrasive particles and secondary particles) for a given area (e.g., ream, wherein 1 ream=30.66 m²) of the backing. For example, in one embodiment, the abrasive article may utilize a normalized weight of particles of at least about 1 lbs/ream (14.8 grams/m²), such as at least 5 lbs/ream or at least 10 lbs/ream or at least about 15 lbs/ream or at least about 20 lbs/ream or at least about 25 lbs/ream or even at least about 30 lbs/ream. Still, in one non-limiting embodiment, the abrasive article can include a normalized weight of particles of not greater than about 90 lbs/ream (1333.8 grams/m²), such as not greater than 80 lbs/ream or not greater than 70 lbs/ream or not greater than 60 lbs/ream or not greater than about 50 lbs/ream or even not greater than about 45 lbs/ream. It will be appreciated that the abrasive articles of the embodiments herein can utilize a normalized weight of particles within a range between any of the above minimum and maximum values.

In certain instances, the abrasive articles can be used on particular workpieces. A suitable exemplary workpiece can include an inorganic material, an organic material, a natural material, and a combination thereof. According to a particular embodiment, the workpiece can include a metal or metal alloy, such as an iron-based material, a nickel-based material, and the like. In one embodiment, the workpiece can be steel, and more particularly, can consist essentially of stainless steel (e.g., 304 stainless steel).

In another embodiment, the fixed abrasive article may be a bonded abrasive, including abrasive particles contained within the three-dimensional volume of the bond material, which can be distinct from certain other fixed abrasive articles including, for example, coated abrasive articles, which generally include a single layer of abrasive particles contained within a binder, such as a make coat and/or size coat. Furthermore, coated abrasive articles generally include a backing as a support for the layer of abrasive particles and binder. By contrast, bonded abrasive articles are generally self-supporting articles including a three-dimensional volume of abrasive particles, bond material, and optionally some porosity. Bonded abrasive articles may not necessarily include a substrate, and can be essentially free of a substrate.

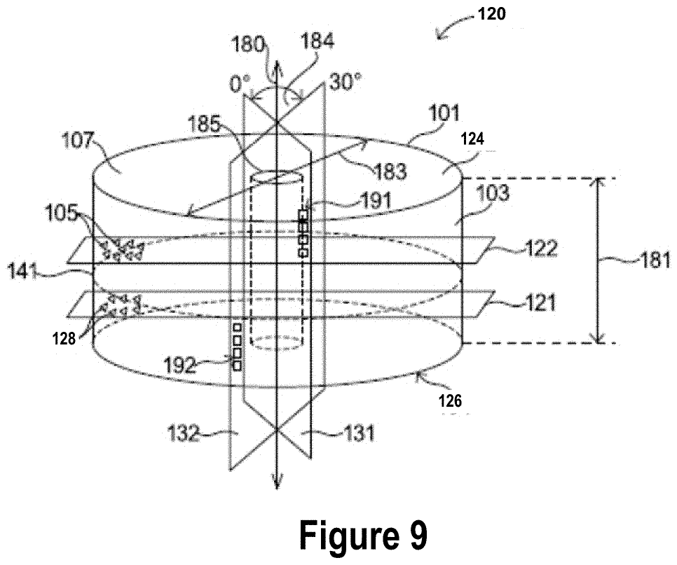

FIG. 9 includes a perspective view illustration of a bonded abrasive article in accordance with an embodiment. As illustrated, the bonded abrasive article 120 can have a body 101 of a generally cylindrical shape including an upper surface 124, a bottom surface 126, and a side surface 103 extending between the upper surface 124 and bottom surface 126. It will be appreciated that the fixed abrasive article of FIG. 9 is a non-limiting example, and other shapes of the body may be utilized including, but not limited to, conical, cup-shaped, depressed center wheels (e.g., T42), and the like. Finally, as further illustrated, the body 101 can include a central opening 185 which may be configured to accept an arbor or shaft for mounting of the body 101 on a machine configured to rotate the body 101 and facilitate a material removal operation.

The bonded abrasive article 120 can have a body 101 including abrasive particles, including for example, the groups of abrasive particles 105 and 128, contained within the volume of the body 101. The abrasive particles may be contained within the three-dimensional volume of the body 101 by a bond material 107 that can extend throughout the three-dimensional volume of the body 101. In accordance with an embodiment, the bond material 107 can include materials such as vitreous, polycrystalline, monocrystalline, organic (e.g., resin), metal, metal alloys, and a combination thereof.

In a particular embodiment, the abrasive particles may be encapsulated within the bond material 107. As used herein, “encapsulated” refers to a condition whereby at least one of the abrasive particles is fully surrounded by a homogenous, or generally homogenous, composition of bond material. In an embodiment, the bonded abrasive article 120 can be essentially free of a fixation layer. In a particular instance, the bonded abrasive article 120 can be substantially uniform throughout a volume of the body 101. In more particular instances, the body 101 can have a substantially homogenous composition throughout the volume of the body 101.

In accordance with an embodiment, the abrasive particles contained within the bonded abrasive article 120 can include abrasive materials in accordance with those described in embodiments herein.

The bonded abrasive article 120 can include a combination of abrasive particles, including one or more types of abrasive particles, such as primary and secondary types of abrasive particles. Primary and secondary types may refer to the content of the abrasive particles within the body of the fixed abrasive article, wherein the primary type abrasive particles are present in a higher content than the secondary type of abrasive particles. In other instances, the distinction between primary and secondary types of abrasive particles may be based upon the position of the abrasive particle within the body, wherein the primary abrasive particles may be positioned to conduct an initial stage of material removal or conduct the majority of material removal compared to the secondary abrasive particles. In still other instances, the distinction between primary and secondary abrasive particles may pertain to the abrasive nature (e.g., hardness, friability, fracture mechanics, etc.) of the abrasive particles, wherein the abrasive nature of the primary particles is typically more robust as compared to the secondary type of abrasive particles. Some suitable examples of abrasive particles that may be considered as a secondary type of abrasive particle include diluent particles, agglomerated particles, unagglomerated particles, naturally occurring materials (e.g., minerals), synthetic materials, and a combination thereof.

In certain instances, the bonded abrasive article 120 can include a particular content of abrasive particles within the body 101 that may facilitate suitable material removal operations. For example, the body 101 can include a content of abrasive particles of at least 0.5 vol % and not greater than 60 vol % for a total volume of the body.

Furthermore, the body 101 of the bonded abrasive article 120 can include a particular content of bond material 107 that may facilitate suitable operation of the bonded abrasive article 120. For example, the body 101 can include a content of bond material 107 of at least 0.5 vol % and not greater than about 90 vol % for a total volume of the body.

In certain instances, the fixed abrasive article can have a body 101 including a content of porosity. The porosity can extend throughout at least a portion of the entire volume of the body 101, and in certain instances, may extend substantially uniformly throughout the entire volume of the body 101. For example, the porosity can include closed porosity or open porosity. Closed porosity can be in the form of discrete pores that are isolated from each other by bond material and/or abrasive particles. Such closed porosity may be formed by pore formers. In other instances, the porosity may be open porosity defining an interconnected network of channels extending throughout at least a portion of the three-dimensional volume of the body 101. It will be appreciated that the body 101 may include a combination of closed porosity and open porosity.

In accordance with an embodiment, the fixed abrasive article can have a body 101 including a particular content of porosity that can facilitate suitable material removal operations. For example, the body 101 can have a porosity of at least 0.5 vol % and not greater than 80 vol % for a total volume of the body.

In accordance with another embodiment, it will be appreciated that the bonded abrasive article 120 can include a body 101 including certain additives that may facilitate certain grinding operations. For example, the body 101 can include additives such as fillers, grinding aids, pore inducers, hollow materials, catalysts, coupling agents, curants, antistatic agents, suspending agents, anti-loading agents, lubricants, wetting agents, dyes, fillers, viscosity modifiers, dispersants, defoamers, and a combination thereof.

As further illustrated in FIG. 9, the body 101 can have a diameter 183, which may be varied according to the desired material removal operation. The diameter can refer to the maximum diameter of the body, particularly in those cases where the body 101 has a conical or cup-shaped contour.

Moreover, the body 101 can have a particular thickness 181 extending along the side surface 103 between the upper surface 124 and the bottom surface 126 along the axial axis 180. The body 101 can have a thickness 181, which may be an average thickness of the body 101, which can be not greater than 1 m.

In accordance with an embodiment, the body 101 may have a particular relationship between the diameter 183 and thickness 181, defining a ratio of diameter:thickness that may be suitable for certain material removal operations. For example, the body 101 can have a ratio of diameter:thickness of at least 10:1, such as at least 15:1, at least 20:1, at least 50:1, or even at least 100:1. It will be appreciated that the body may have a ratio of diameter:thickness of not greater than 10,000:1 or not greater than 1000:1.

The bonded abrasive article 120 may include at least one reinforcing member 141. In particular instances, the reinforcing material 141 can extend for a majority of the entire width (e.g., the diameter 183) of the body 101. However, in other instances, the reinforcing member 141 may extend for only a fraction of the entire width (e.g., diameter 183) of the body 101. In certain instances, the reinforcing member 141 may be included to add suitable stability to the body for certain material removal operations. In accordance with an embodiment, the reinforcing member 141 can include a material such as a woven material, a nonwoven material, a composite material, a laminated material, a monolithic material, a natural material, a synthetic material, and a combination thereof. More particularly, in certain instances, the reinforcing member 141 can include a material such as a monocrystalline material, a polycrystalline material, a vitreous material, an amorphous material, a glass (e.g., a glass fiber), a ceramic, a metal, an organic material, an inorganic material, and a combination thereof. In particular instances, the reinforcing material 141 may include fiberglass, and may be formed essentially from fiberglass.

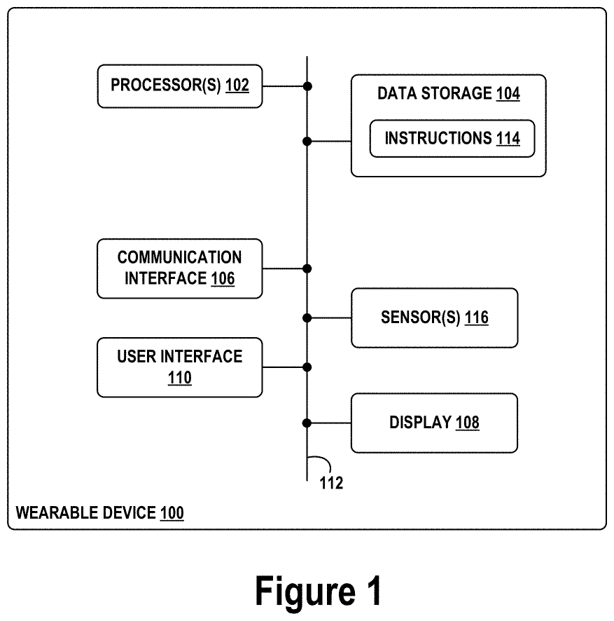

In particular instances, the reinforcing material 141 can be substantially contained within the three-dimensional volume of the body 101, more particularly, within the three-dimensional volume of the bond material 107. In certain instances, the reinforcing material 141 may intersect an exterior surface of the body 101 including, but not limited to, the upper surface 124, side surface 103, and/or bottom surface 126. For example, the reinforcing material 141 can intersect the upper surface 124 or bottom surface 126. In at least one embodiment, the reinforcing material 141 may define the upper surface 124 or bottom surface 126 of the body 101, such that the bond material 107 is disposed between one or more reinforcing materials. It will be appreciated that while a single reinforcing member 141 is illustrated in the embodiment of FIG. 1, a plurality of reinforcing members may be provided within the body 101 in a variety of arrangements and orientations suitable for the intended material removal application.

As further illustrated, the body 101 can include certain axes and planes defining the three-dimensional volume of the body 101. For example, the body 101 of the fixed abrasive article 120 can include an axial axis 180. As further illustrated along the axial axis 180, the body 101 can include a first axial plane 131 extending along the axial axis 180 and through a particular diameter of the body 101 at a particular angular orientation, designated herein as 0°. The body 101 can further include a second axial plane 132 distinct from the first axial plane 131. The second axial plane 132 can extend along the axial axis 180 and through a diameter of the body 101 at an angular position, as designated by example herein as 30°. The first and second axial planes 131 and 132 of the body 101 may define particular axial collections of abrasive particles within the body 101 including, for example, the axial collection of abrasive particles 191 within the axial plane 131 and the axial collection of abrasive particles 192 within the axial plane 132. Furthermore, the axial planes of the body 101 may define sectors there between, including for example, sector 184 defined as the region between the axial planes 131 and 132 within the body 101. The sectors can include a particular group of abrasive particles that may facilitate improved material removal operations. Reference herein to features of portions of abrasive particles within the body, including for example, abrasive particles within axial planes will also be relevant to groups of abrasive particles contained within one or more sectors of the body.

As further illustrated, the body 101 can include a first radial plane 121 extending along a plane that is substantially parallel to the upper surface 124 and/or bottom surface 126 at a particular axial location along the axial axis 180. The body can further include a second radial plane 122, which can extend in a substantially parallel manner to the upper surface 124 and/or bottom surface 126 at a particular axial location along the axial axis 180. The first radial plane 121 and second radial plane 122 can be separated from each other within the body 101, and more particularly, the first radial plane 121 and second radial plane 122 can be axially separated from each other. As further illustrated, in certain instances, one or more reinforcing members 141 may be disposed between the first and second radial planes 121 and 122. The first and second radial planes 121 and 122 may include one or more particular groups of abrasive particles including, for example, the group of abrasive particles 128 of the first radial plane 121 and the group of abrasive particles 105 of the second radial plane 122, which may have certain features relative to each other that may facilitate improved grinding performance.

The abrasive particles of the embodiments herein can include particular types of abrasive particles. For example, the abrasive particles may include shaped abrasive particles and/or elongated abrasive particles, wherein the elongated abrasive particles may have an aspect ratio of length:width or length:height of at least 1.1:1. Various methods may be utilized to obtain shaped abrasive particles. The particles may be obtained from a commercial source or fabricated. Some suitable processes used to fabricate the shaped abrasive particles can include, but is not limited to, depositing, printing (e.g., screen-printing), molding, pressing, casting, sectioning, cutting, dicing, punching, pressing, drying, curing, coating, extruding, rolling, and a combination thereof. Similar processes may be utilized to obtain elongated abrasive particles. Elongated unshaped abrasive particles may be formed through crushing and sieving techniques.

In an embodiment, a system may include a wearable device that could obtain real-time data that may be used to determine abrasive operational data. To obtain real-time data, the wearable device may include embedded sensors that can collect data in real-time from an environment of the tool and/or from the tool itself. For instance, the sensors may include an accelerometer that may be operable to measure and record acceleration information in three axes (x, y, and z). Thus, when the operator performs an abrasive operation while wearing the wearable device, the device could measure and record acceleration information related to the tool that is being used to perform the operation. In this scenario, the acceleration information may be used to determine an extent of vibration of the tool.

The vibration data, which is an example of abrasive operational data, could be used to extrapolate other abrasive operational data. As an example, the vibration data may be used to determine operational information of the tool, such as an operational status and operational hours. For instance, the operational status could include “OFF”, “IDLE”, “SANDING”, “SANDING WITH AN UNBALANCED DISC”, or “SANDING WITH A WORN DISC,” among other possibilities. As another example, the vibration data may be used to determine grinding information of the performed abrasive operation, such as a working angle, a grip tightness, an applied pressure, an angular velocity (e.g., revolutions per minute, RPM), among other variables.

In some embodiments, the system may additionally include remote sensors that are disposed in an environment in which an operation is being performed. Additionally and/or alternatively, the system may include sensors that are embedded in the abrasive tool (e.g., within a handle, a body of the tool, and/or coupled to an abrasive product). The wearable device may be configured to communicate with the remote sensors and/or with the one or more sensors associated with the abrasive product or tool.

As an example, the abrasive tool could include an optical or magnetic sensor operable to provide information about an angular velocity (RPM) of a grinding wheel or disc. In such scenarios, the wearable device could be configured to communicate with the grinding tool so as to associate the RPM information with the vibration information obtained by the wearable device. Then the RPM and/or the vibration information may be used to determine grinding power and/or applied grinding force of the grinding tool. As another example, the wearable device could provide instructions to the grinding tool so as to adjust an operating mode of the grinding tool. In some embodiments, the wearable device could instruct the grinding tool to adjust an RPM, turn on, and/or turn off based on the noise and/or vibration information. For instance, if the wearable device determines that the operation of the grinding tool is unsafe based on the noise and/or vibration data, the wearable device could instruct the grinding tool to shut down.

Additionally, the wearable device may include a communication interface to transmit the collected data to a remote server. The communication interface could include Wi-Fi connectivity and access to cloud computing and/or cloud storage capabilities. Accordingly, the wearable device could provide real-time information to a remote server, which could provide real-time feedback about the grinding/abrasive operation. In such a way, the systems and methods described herein could provide real-time information about one or more performance indicators that relate to the grinding/abrasive operation.

Additionally, the remote server may store the received data. The remote server may then analyze or mine the data that is stored over a period of time (also referred to herein as “historical data”), perhaps to make one or more determinations associated with the grinding tool. In an example, the remote server may determine operation or enterprise improvements (e.g., identification and teaching of best operational practices). In another example, the remote server may compare different value metrics (e.g., vibration, noise, productivity, product life, etc.) for different abrasive articles used in a given application, perhaps across many users.

Furthermore, the wearable devices could be communicatively coupled to one or more cloud computing devices. In some embodiments, the wearable device could be operable to run web applications, which could include event-driven scripts operating in a Node.js (e.g., JavaScript everywhere) runtime environment, among other possibilities. Namely, the wearable device could be configured to communicate with the cloud computing devices in a real-time and/or asynchronous fashion. In an example embodiment, the application data detected and/or generated by the wearable device could be synchronized across client devices and/or cloud computing devices by way of real-time database and storage software, such as Firebase. In some embodiments, the wearable device could be configured to communicate with the remote computing device using Message Queuing Telemetry Transport (MQTT) or another type of messaging protocol.

### II. Illustrative Wearable Devices

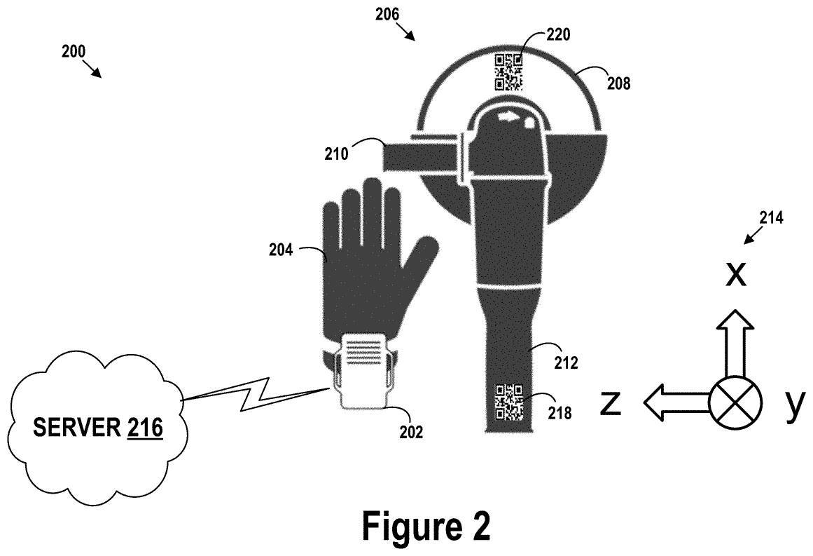

FIG. 1 illustrates a block diagram of a wearable device 100, according to an example embodiment. The wearable device 100 may include a mount, such as a belt, wristband, ankle band, necklace, or adhesive substrate, etc., that can be used to mount the device at, on, or in proximity to a body surface of a user. Accordingly, the wearable device 100 may take the form of any device that is configured to be mounted on, in, encircling, or adjacent to a body surface of a user. In an example implementation, the wearable device 100 could be mounted to a protective glove worn by the user. Additionally or alternatively, the wearable device 100 could include a wristband and could be worn similar to a wristwatch (e.g., wearable device 202 in FIG. 2).

In some examples, the wearable device 100 may be provided as or include a head mountable device (HMD). An HMD may generally be any display device that is capable of being worn on the head and places a display in front of one or both eyes of the wearer. Such displays may occupy a wearer's entire field of view, or occupy only a portion of a wearer's field of view. Further, head-mounted displays may vary in size, taking a smaller form such as a glasses-style display or a larger form such as a helmet or eyeglasses, for example. The HMD may include one or more sensors positioned thereon that may contact or be in close proximity to the body of the wearer.

As shown in FIG. 1, the wearable device 100 may include one or more sensors 116 for collecting data, a data storage 104, which may store the collected data and may include instructions 114, one or more processor(s) 102, a communication interface 106 for communicating with a remote source (e.g., a server or another device/sensor), and a display 108. Additionally, the wearable device 100 may include an audio output device (e.g., a speaker) and a haptic feedback device (e.g., an eccentric rotating mass (ERM) actuator, linear resonant actuator (LRA), or piezoelectric actuators, among other examples).

The one or more sensors 116 may be configured to collect data in real-time from or associated with an environment of the wearable device 100. Real-time collection of data may involve the sensors periodically or continuously collecting data. For example, the one or more sensors 116 may include a sound detection device (e.g., a microphone) that is configured to detect sound in the environment of the sensor (e.g., from an abrasive tool operating in proximity of the sensor). Additionally and/or alternatively, the sensors 116 may be configured to collect data from or associated with an operator of the wearable device 100. For example, the one or more sensors 116 may include an accelerometer (e.g., a tri-axis accelerometer) that is configured to measure acceleration of the operator (e.g., acceleration of a hand of the operator on which the wearable device 100 is mounted). As described herein, the data collected by the one or more sensors 116 may be used to determine abrasive operational data, which could then be used for obtaining real-time data about grinding/abrasive operations, capturing a user experience of a user that is using the tool, and/or determining operational and/or or enterprise improvements (e.g., based on data collected over a period of time).

The one or more sensors 116 may also include other sensors for detecting movement, such IMUs and gyroscopes. Further, the one or more sensors 116 may include other types of sensors such as location-tracking sensors (e.g., a GPS or other positioning device), light intensity sensors, thermometers, clocks, force sensors, pressure sensors, photo-sensors, Hall sensors, vibration sensors, sound-pressure sensors, a magnetometer, an infrared sensor, cameras, and piezo sensors, among other examples. These sensors and their components may be miniaturized so that the wearable device 100 may be worn on the body without significantly interfering with the wearer's usual activities. The one or more sensors 116 may be battery powered or may have an internal energy harvesting mechanism (e.g., a photovoltaic energy harvesting system or a piezoelectric energy harvesting system) to make them “self powered”.

The processor 102 may be configured to control the one or more sensors 116 based, at least in part, on the instructions 114. As will be explained below, the instructions 114 may be for collecting real-time data. Further, the processor 102 may be configured to process the real-time data collected by the one or more sensors 116. Yet further, the processor 102 may be configured to convert the data into information indicative of the behavior of an abrasive tool or the user experience of the user using the tool.

The data storage 104 is a non-transitory computer-readable medium that can include, without limitation, magnetic disks, optical disks, organic memory, and/or any other volatile (e.g. RAM) or non-volatile (e.g. ROM) storage system readable by the processor 102. The data storage 104 can include a data storage to store indications of data, such as sensor readings, program settings (e.g., to adjust behavior of the wearable device 100), user inputs (e.g., from a user interface on the device 100 or communicated from a remote device), etc. The data storage 104 can also include program instructions 114 for execution by the processor 102 to cause the device 100 to perform operations specified by the instructions. The operations could include any of the methods described herein.

The communication interface 106 can include hardware to enable communication within the wearable device 100 and/or between the wearable device 100 and one or more other devices. The hardware can include transmitters, receivers, and antennas, for example. The communication interface 106 can be configured to facilitate communication with one or more other devices, in accordance with one or more wired or wireless communication protocols. For example, the communication interface 106 can be configured to facilitate wireless data communication for the wearable device 100 according to one or more wireless communication standards, such as one or more IEEE 801.11 standards, ZigBee standards, Bluetooth standards, LoRa (low-power wide-area network), etc. For instance, the communication interface 106 could include WiFi connectivity and access to cloud computing and/or cloud storage capabilities. As another example, the communication interface 106 can be configured to facilitate wired data communication with one or more other devices.

The display 108 can be any type of display component configured to display data. As one example, the display 108 can include a touchscreen display. As another example, the display 108 can include a flat-panel display, such as a liquid-crystal display (LCD) or a light-emitting diode (LED) display.

The user interface 110 can include one or more pieces of hardware used to provide data and control signals to the wearable device 100. For instance, the user interface 110 can include a mouse or a pointing device, a keyboard or a keypad, a microphone, a touchpad, or a touchscreen, among other possible types of user input devices. Generally, the user interface 110 can enable an operator to interact with a graphical user interface (GUI) provided by the wearable device 100 (e.g., displayed by the display 108). As an example, the user interface 110 may allow an operator to provide an input indicative of a task to be performed by the operator. As another example, the operator may provide an input indicative of a tool to be used to perform the operation and/or an input indicative of a workpiece on which the operator may perform the abrasive operation.

FIG. 2 illustrates a scenario 200 of using a wearable device 202, according to an example embodiment. As shown in FIG. 2, the wearable device 202 is in the form of a wrist-mountable device 202 that is mounted onto a wrist of a user's hand 204. The user's hand 204 may be a dominant hand of the operator that is favored by the operator when performing tasks. Here, the operator may use hand 204 (on which the wearable device 202 is mounted) to grasp a handle 210 or a handle 212 of an abrasive tool 206 (which may also be referred to herein as an “abrasive device”). In some examples, the user may wear a wearable device on both wrists. In other examples, the wearable device 202 may be directly attached to abrasive tool 206, perhaps being wrapped around or otherwise attached at handle 210 or at handle 212.

Within examples, the abrasive tool 206 may be any tool that is configured to perform manual grinding operations on a work piece (not illustrated in FIG. 2). Such manual grinding operations could include grinding, polishing, buffing, honing, cutting, drilling, sharpening, filing, lapping, sanding, and/or other similar tasks. However, other types of manual mechanical operations that may include vibration and/or noise are contemplated. For example, hammering, chiseling, crimping, striking, or other manual operations are possible within the context of the current disclosure.

Accordingly, the abrasive tool 206 may be a device that is configured to perform one or more of the abrasive operations. For example, the abrasive tool 206 may be a right angle grinding tool, a power drill, a hammer drill and/or percussion hammer, a saw, a plane, a screwdriver, a router, a sander, an angle grinder, a garden appliance and/or a multifunction tool, among other examples.

Furthermore, the abrasive tool 206 may include one or more components that enable the tool to perform one or more of the abrasive operations. In particular, the tool 206 may include an abrasive article for performing the one or more operations described. The abrasive article may include one or more materials that may be used to shape or finish a workpiece. The one or more materials may include an abrasive mineral such as calcite (calcium carbonate), emery (impure corundum), diamond dust (e.g., synthetic diamonds), novaculite, pumice, rouge, sand, corundum, garnet, sandstone, tripoli, powdered feldspar, staurolite, borazon, ceramic, ceramic aluminium oxide, ceramic iron oxide, corundum, glass powder, steel abrasive, silicon carbide (carborundum), zirconia alumina, boron carbide, and slags. Additionally and/or alternatively, the one or more materials may include a composite material that includes a coarse-particle aggregate that is pressed and bonded together using a bond. The composite material may include clay, a resin, a glass, a rubber, aluminum oxide, silicon carbide, tungsten carbide, garnet, and/or gardner ceramic.

Furthermore, the abrasive article may have one of many shapes. For instance, the article may take the form of a block, a stick, a wheel, a ring, or a disc, among other examples. In the example shown in FIG. 2, the abrasive tool 206 may include a wheel shaped abrasive article 208.

Additionally, the abrasive tool 206 may include a power source that may be configured to actuate the abrasive article to perform an operation. Within examples, the power source may be an electric motor, a petrol engine, or compressed air. The abrasive tool 206 may also include a housing that houses the power source. The housing may be formed from hard plastic, phenolic resin, or medium-hard rubber, among other examples.

The abrasive tool 206 may include an identifying feature 218, such as a scannable identifier (e.g., QR code, barcode, serial number, etc.) that may be engraved in or affixed to the tool 206. The identifying feature may be used to identify a type of the tool 206, a manufacturer of the tool 206, a model of the tool 206, and/or a unique identifier of the tool 206. Additionally and/or alternatively, the components of the abrasive tool 206 may include an identifying feature. For instance, the abrasive article 208 may include an identifying feature 220 that is engraved in and/or affixed to the abrasive article. The identifying feature may be used to identify a type of the abrasive article, a manufacturer of the abrasive article, a model of the abrasive article, and/or a unique identifier of the abrasive article.

In an embodiment, the one or more sensors of the wearable device 202 may be configured to read or scan the identifying feature 218 of the abrasive tool 206. In an example, the sensor may be an image capture device (e.g., a camera) that may capture and analyze images of the tool 206 in order to determine a type of the tool 206. In another example, the sensor may be a scanner that is configured to scan an identifying image or code on the tool 206. For instance, the sensor may be a QR code scanner that is configured to read identifying feature 218 (e.g., a QR code) affixed to the tool 206. Other sensors that could be used for identification purposes, such as barcode scanners and RF readers, are also contemplated herein. The one or more sensors may also be configured to read or scan any other identifying features of the tool 206, such as an identifying feature 220 of the abrasive article 208.

Identifying the tool 206 and/or the components thereof, may allow the wearable device 202 to provide the operator with information associated with the tool 206 and/or the components thereof. Additionally and/or alternatively, the identification may allow the wearable device 202 to associate data collected by one or more sensors in the environment with the particular tool 206 and/or the particular component being used to perform the desired operation.

In the scenario 200, one or more sensors of the wearable device 202 may continuously or periodically collect data from or associated with an environment of the device 202 and/or data from or associated with the operator. As also explained herein, one or more additional sensors disposed in the environment may additionally collected data from or associated with the environment of the device 202 and/or data from or associated with the operator. The data collected by the wearable device 202 that relates to the tool 206 may be used to determine abrasive operational data. The abrasive operational data may include sound data indicative of sounds emitted by the tool 206, acceleration data collected by the wearable device 202, vibration data indicative of a vibration of the tool 206, and/or data extrapolated from the sound, acceleration, and/or vibration data (e.g., applied force data, RPM data, usage rate, etc.).

In an embodiment, the one or more sensors may collect information indicative of the workpiece. In an example, an image capture device (e.g., a camera) of the wearable device 202 may be configured to capture an image of the workpiece. The image may be analyzed in order to determine a status of the workpiece, including a type of the workpiece, dimensions of the workpiece, surface characteristics of the workpiece, and/or an arrangement of the workpiece in the environment (e.g., orientation, angle, position with respect to a reference point in the environment (e.g., with respect to the tool 206), etc.).

In an embodiment, a microphone of the wearable device 202 may be configured to collect sound data. When the user is operating the tool 206 while wearing the wearable device 202, the microphone may collect sound emitted by the tool 206. The collected sound data may be analyzed by the wearable device 202 in order to extrapolate information. By way of example, the collected sound data may be used to determine an RPM at which the abrasive product 208 is operating. In particular, the wearable device 202 may analyze an amplitude of the sound data in order to determine an estimated RPM value of the abrasive product 208. In some examples, the wearable device 202 may use a table that correlates sound amplitude to an estimated RPM value at which the tool 206 is operating. The correspondence between the sound amplitude and the estimated RPM value may vary depending on a type of the tool 206.

Additionally, the determined RPM value may be used to extrapolate other abrasive operational data. For example, the wearable device 202 may use the RPM value to determine a grinding power of the tool 206. The wearable device 202 may do so by using a data (e.g., a table) indicative of a correlation between an RPM of a particular tool and the grinding power exerted by the tool. Accordingly, the wearable device 202 may seek to identify the tool 206 before extrapolating the grinding power from the RPM value. As another example, the wearable device 202 may use the RPM value to determine a force that is applied to the work piece. The wearable device 202 may do so by using a data (e.g., a table) indicative of a correlation between an RPM of a particular tool and the grinding power exerted by the tool.

In an embodiment, an accelerometer of the wearable device 202 may be configured to collect acceleration data of the user, particularly acceleration data related to the user's hand 204. When the user is operating the tool 206, the user's hand may vibrate as a result of the tool 206 vibrating when being used. Accordingly, the accelerometer may measure the hand's acceleration as a result of the vibration. Because the hand's vibration is a result of the tool's vibration, the acceleration information collected by the accelerometer may be indicative of the vibration of the tool.

In an implementation, the accelerometer may be a tri-axis accelerometer that is operable to measure and record acceleration information in three axes (x, y, and z). The measured acceleration information may be used to calculate a gRMS value, which may be indicative of the energy dispersed in a repetitive vibration system. In particular, the gRMS value may be calculated using an RMS value of acceleration (arms), where arms may be calculated as:

$${a}_{rms} = \sqrt{\frac{{\sum }_{i = 0}^{N} {( {a}_{xi} - \overline{{a}_{x}} )}^{2} + {( {a}_{yi} - \overline{{a}_{y}} )}^{2} + {( {a}_{zi} - \overline{{a}_{z}} )}^{2}}{N}}$$

$$where , \\ \overline{{a}_{x}} = \frac{1}{N} {\sum }_{i = 0}^{N} {a}_{xi}$$

$$\overline{{a}_{y}} = \frac{1}{N} {\sum }_{i = 0}^{N} {a}_{yi}$$

$$\overline{{a}_{z}} = \frac{1}{N} {\sum }_{i = 0}^{N} {a}_{zi}$$

The gRMS value may be obtained from the RMS value of the acceleration (arms). In particular, the gRMS value may be the RMS value of the acceleration, where the acceleration is expressed in g's. As explained herein, the gRMS value may be indicative of the vibration of the tool 206.

In an embodiment, the wearable device 202 may include multiple (e.g., 2, 3, 10, or N) accelerometers. Each of the multiple accelerometers may be a different type of accelerometer. For example, one of the multiple accelerometers may be a piezoelectric accelerometer whereas another one of the multiple accelerometers may be a micro-electro mechanical system (MEMS) accelerometer. Each of the multiple accelerometers may be configured to collect acceleration data within a particular vibration range and at a particular sampling rate. For example, if the wearable device 202 has two accelerometers, one of the accelerometers may be configured to collect data in the 10 to 500 Hz range every 1 ms while the other accelerometer may be configured to collect data in the 500 to 1000 Hz range every 0.5 ms. The use of multiple accelerators may allow the wearable device 202 to detect vibrations in a larger measurement range and may allow for more precise measurements within each measurement range.

In an embodiment, the abrasive operational data may be used to determine information relating to the abrasive tool 206. In one example, the information may be indicative of one or more grinding parameters of the abrasive tool 206. The one or more grinding parameters may include an angular velocity (e.g., revolutions per minute, RPM) of the abrasive article, a working angle, a grip tightness, an applied pressure, a severity of the operation, and shocks experienced by the tool. In another example, the information may be indicative of operational information of the tool, such as an operational status and operational hours. In yet another example, the information may be indicative of a condition of the abrasive tool 206 or one or more components thereof (e.g., the abrasive article). For instance, the condition may be indicative of damage to or unbalance in the abrasive article 208.

In another embodiment, the abrasive operational data may be used to determine information relating to the user. For example, the information relating to the user may include a length of time spent performing assigned tasks, idle time, and/or productive time. For instance, the sound data and/or the vibration data may be used to determine when the tool 206 is in operation.

In an embodiment, the wearable device 202 may analyze the data to determine the information relating to the abrasive tool 206 and/or the user. The wearable device 202 may also be communicatively coupled to a remote server 216, and may provide the server with the real-time data collected by the sensors. Therefore, the server 216 may, additionally and/or alternatively, convert the data to the information relating to the abrasive tool 206 and/or the user.

Furthermore, the remote server 216 may analyze the data to provide real-time feedback and/or notifications related to the abrasive operations. In such a way, the remote server 216 may provide real-time information about one or more performance indicators that relate to the grinding/abrasive operation. Based on the indicators provided by the server 216, the wearable device 202 may determine to provide the user with a specific notification or feedback.

As an example, based on an analysis of the sensor data, the server 216 may determine that an abrasive article of the abrasive tool is damaged or malfunctioning. For instance, the server 216 may analyze the acceleration and/or noise data to determine that the abrasive article is damaged and/or unbalanced. More specifically, the server 216 may detect one or more patterns in the acceleration and/or noise data that may be indicative of a damaged or malfunctioning abrasive article. For instance, a first pattern of spikes or peaks may be indicative of a damaged abrasive tool and a second pattern of spikes or peaks may be indicative of a malfunctioning abrasive tool.

The server 216 may then provide the wearable device 202 with an indication that the abrasive article is damaged or malfunctioning. In response to receiving the indication, the wearable device 202 may output a visual, haptic, and/or audio alert that indicates to the user that the abrasive article is damaged or malfunctioning. Additionally, the alert may provide the user with an option to order a replacement article or to request maintenance for the article.

As another example, based on an analysis of the sensor data, the server 216 may determine that the abrasive wheel 208 is unbalanced. The determination may be based on an analysis of the acceleration and/or noise data. More specifically, the server 216 may detect one or more patterns in the acceleration and/or noise data that may be indicative of a damaged or malfunctioning abrasive article. For instance, a particular pattern of spikes or peaks may indicate an unbalanced abrasive wheel.

The server 216 may then provide the wearable device 202 with an indication that the abrasive wheel 208 is unbalanced. In response to receiving the indication, the wearable device 202 may output a visual, haptic, and/or audio alert that indicates to the user that the abrasive wheel is unbalanced.

As yet another example, based on an analysis of the sensor data, the server 216 may determine that a severity of the operation being performed exceeds a threshold severity for the abrasive tool 206. For instance, the determination may be based on an analysis of the acceleration and/or noise data. More specifically, the server 216 may detect peaks in the acceleration and/or noise data that may indicate that the severity of the operation exceeds a threshold severity. The server 216 may then provide the wearable device 202 with an indication that the threshold severity has been exceeded. In response to receiving the indication, the wearable device 202 may output a visual, haptic, and/or audio alert that indicates to the user that the threshold severity is being exceeded.

As yet another example, based on an analysis of the data, the server 216 may determine that the user is incorrectly performing an operation. For instance, the determination may be based on gyroscope data and any information available to the server 216 indicative of the work piece on which the operation is being performed (e.g., based on sensor data, such as an image, indicative of the workpiece). In particular, the server 216 may use the data indicative of the workpiece to determine an angle of the workpiece relative to a reference frame of the gyroscope. Then, the server 216 may determine based on the gyroscope data that the user is positioning the abrasive tool at an angle that is different from a recommended angle (which is determined based on information about the operation and/or the work piece).

The server 216 may then provide the wearable device 202 with an indication that the user is performing the operation incorrectly. In response to receiving the indication, the wearable device 202 may output a visual, haptic, and/or audio alert that indicates to the user that the user is performing the operation incorrectly. Additionally and/or alternatively, the wearable device 202 may provide the user with feedback indicative of correct performance of the operation.

As yet another example, based on an analysis of the data, the server 216 may determine a status of the user. For instance, the determination may be based on an analysis of the acceleration and/or noise data. More specifically, based on a duration of the acceleration and/or noise data being greater than a threshold duration, the server 216 may determine that the user has been performing operations for at least a threshold period of time.

The server 216 may then provide the wearable device 202 with an indication that the user has been performing operations for a threshold period of time. The wearable device may then provide the user with a visual, haptic, and/or audio alert that the user has been performing operations for a threshold period of time.

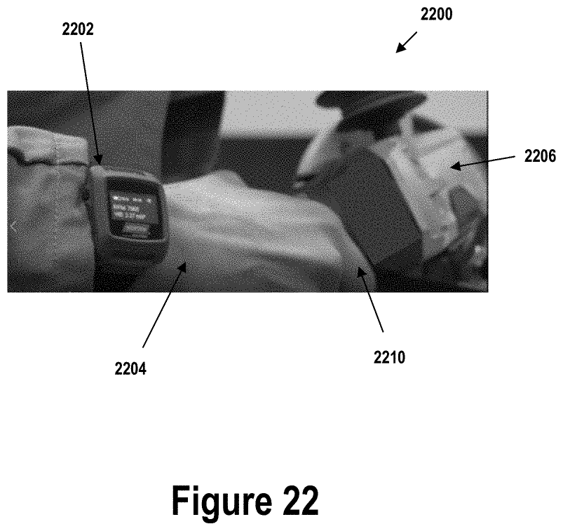

As another example of a wearable device, FIG. 22 is provided. In particular, FIG. 22 illustrates a scenario 2200 of using a wearable device 2202, according to an example embodiment. Wearable device 2202 is in the form of a wrist-watch that is attached onto a wrist of a user's hand 2204. In turn, hand 2204 grasps handle 2210 of abrasive tool 2206.

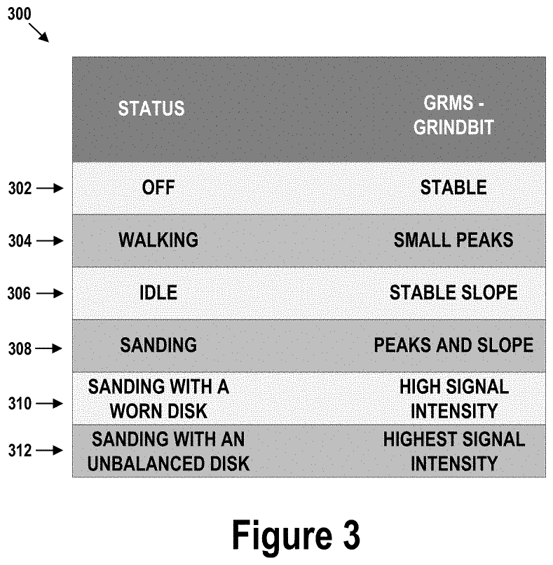

FIG. 3 illustrates a table 300 of example operational statuses, according to an example embodiment. In particular, for each operational status, the table 300 indicates a pattern in the vibration data (e.g., gRMS data) that is indicative of the respective operational status. As shown by row 302, the server may determine that an operational status of the abrasive tool is “off” if the server detects a stable pattern in the vibration data. As shown by row 304, the server may determine that a status of a user is “walking” if the server detects small peaks in the vibration data. As shown by row 306, the server may determine that an operational status of the abrasive tool is “idle” if the server detects a stable slope in the vibration data. As shown by row 308, the server may determine that an operational status of the abrasive tool is “sanding” if the server detects a peaks and a steady slope in the vibration data. As shown by row 310, the server may determine that an operational status of the abrasive tool is “sanding with a worn” if the server detects a vibration signal intensity greater than a first threshold. As shown by row 312, the server may determine that an operational status of the abrasive tool is “sanding with an unbalanced disk” if the server detects a vibration signal intensity greater than a second threshold greater than the first threshold. The operational statuses of table 300 are example operational statuses and other example operational statuses are contemplated herein.

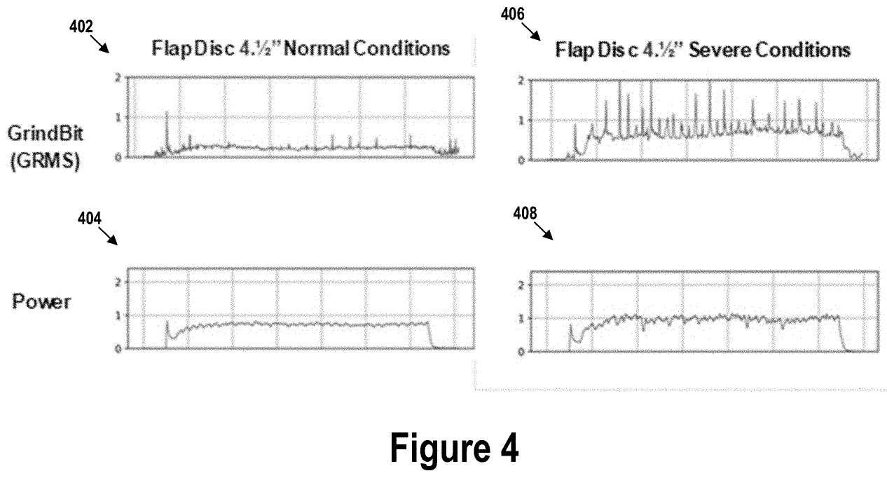

FIGS. 4, 5, 6A, 6B, 7, and 8 each depict graphs of example acceleration and/or vibration data collected by a wearable device under different conditions. The graphs may be used to extrapolate data patterns that are indicative of a particular condition or a performance indicator. As explained herein, a computing system may use one or more data analysis methods to extrapolate the patterns. These methods include machine learning (e.g., Bayesian classifiers, support vector machines, linear classifiers, k-nearest-neighbor classifiers, decision trees, random forests, and neural network), Fast Fourier Transform (FFT), artificial intelligence (AI) methods (e.g., neural networks, fuzzy logic, cluster analysis, or pattern recognition), filtering, peak value, mean, standard deviation, skewness, and/or kurtosis.

FIG. 4 illustrates graphs 402, 404, 406, and 408, according to an example embodiment. In particular, the graphs depict a power signal of the abrasive tool and vibration data of the tool under two testing conditions. The first test condition involves a user performing an operation under normal conditions using an abrasive device that includes a 4.5 inch flap disk. Graph 402 depicts the vibration data collected by a wearable device worn by the user performing the operation and graph 404 depicts the power signal of the abrasive tool. The second test condition involves the user performing an operation under severe conditions using the abrasive device that includes the 4.5 inch flap disk. Graph 406 depicts the vibration data collected by the wearable device and graph 408 depicts the power signal of the abrasive tool.

In an embodiment, these graphs may be used to extrapolate a correlation between a power signal supplied to a tool during an operation and vibration of the tool during the operation. As shown by these graphs, the amplitude of the vibration data may increase as the power signal increases. Accordingly, the vibration data may be used to determine whether a power signal is being provided to the abrasive tool. For example, vibration data with an amplitude greater than a threshold for at least a threshold period of time may be indicative of the abrasive tool being powered for a period time that the amplitude is greater than the threshold. Furthermore, vibration data with an amplitude greater than a second threshold for at least a threshold period of time may be indicative of the abrasive tool operating under severe conditions for a period of time that the amplitude of the vibration data is greater than the second threshold.

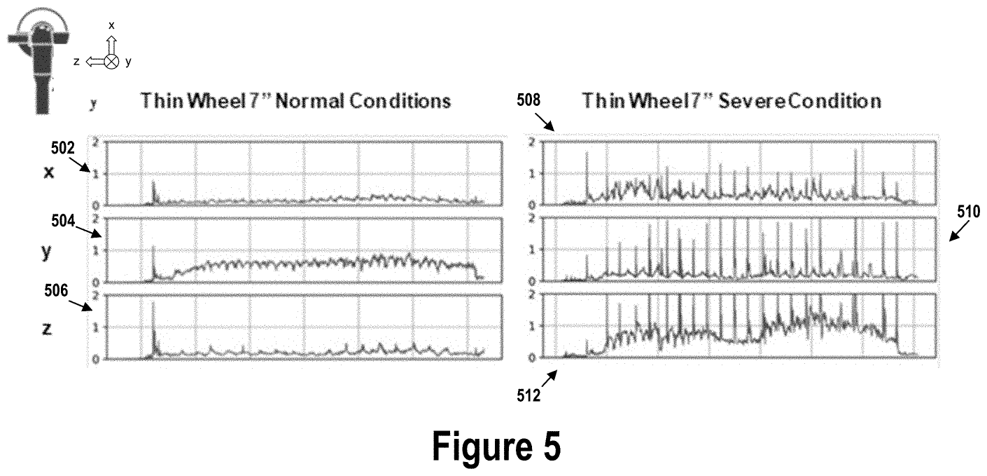

FIG. 5 illustrates graphs 502, 504, 506, 508, 510, and 512, according to an example embodiment. Each of the graphs depicts an acceleration signal of a respective axis measured by a wearable device worn by a user that is using an abrasive tool that includes a 7 inch thin abrasive wheel under two testing conditions. The first test condition involves the user performing an operation under normal conditions using the abrasive device. Graph 502 depicts the acceleration data in the x-axis, graph 504 depicts the acceleration data in the y-axis, and graph 506 depicts the acceleration data in the z-axis under the first test condition. The second test condition involves the user performing an operation under severe conditions using the abrasive device. Graph 508 depicts the acceleration data in the x-axis, graph 510 depicts the acceleration data in the y-axis, and graph 512 depicts the acceleration data in the z-axis under the second test condition.

In an embodiment, a level of severity of operating the abrasive tool may be extrapolated from the acceleration data depicted in the graphs 502-512. In particular, when operating the abrasive tool under severe conditions, the acceleration data includes higher peaks than when operating the abrasive tool under normal conditions. Specifically, the severe condition acceleration data in each of the three axes has higher peaks/amplitudes than the normal condition acceleration data. Accordingly, peaks greater than a threshold in the vibration data of each axis may be indicative of a severe operating condition.

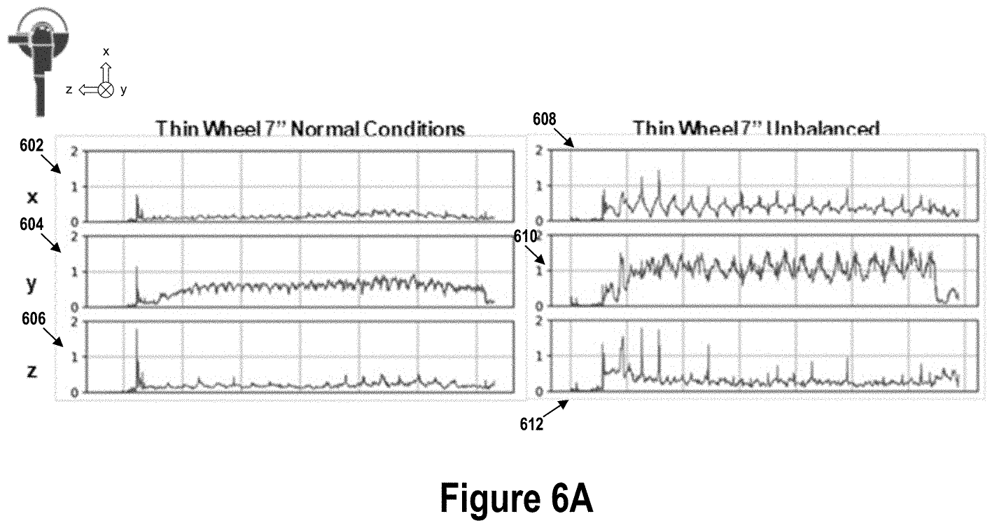

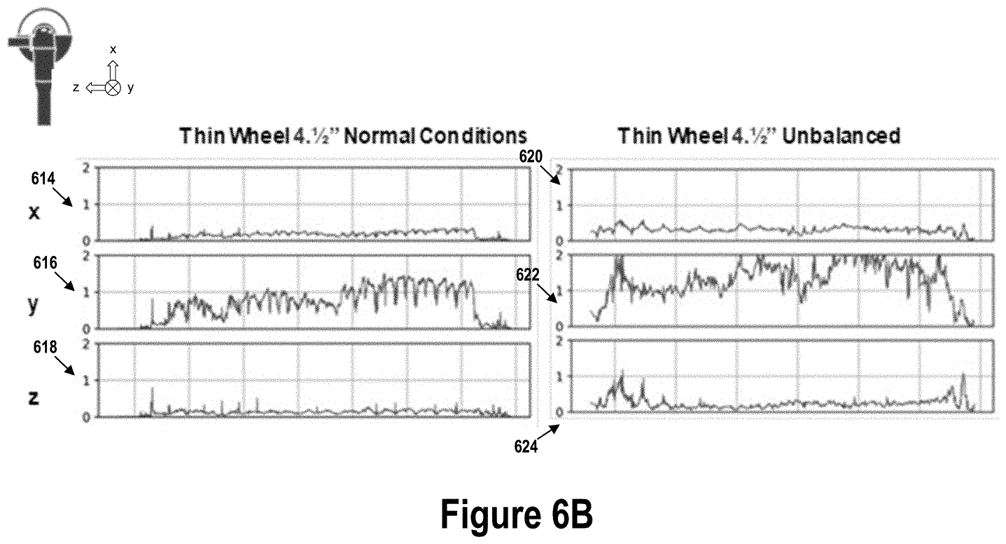

FIG. 6A illustrates graphs 602, 604, 606, 608, 610, and 612, according to an example embodiment. Each of the graphs depicts an acceleration signal of a respective axis measured by a wearable device worn by a user that is using an abrasive tool that includes a 7 inch thin abrasive wheel under two testing conditions. The first test condition involves the user performing an operation under normal conditions using the abrasive device. Graph 602 depicts the acceleration data in the x-axis, graph 604 depicts the acceleration data in the y-axis, and graph 606 depicts the acceleration data in the z-axis under the first test condition. The second test condition involves the user performing an operation using an abrasive device that includes an unbalanced 7 inch thin abrasive wheel. Graph 608 depicts the acceleration data in the x-axis, graph 610 depicts the acceleration data in the y-axis, and graph 612 depicts the acceleration data in the z-axis under the second test condition.

FIG. 6B illustrates graphs 614, 616, 618, 620, 622, and 624, according to an example embodiment. Each of the graphs depicts an acceleration signal of a respective axis measured by a wearable device worn by a user that is using an abrasive tool that includes a 4.5 inch thin abrasive wheel under two testing conditions. The first test condition involves the user performing an operation under normal conditions using the abrasive device. Graph 614 depicts the acceleration data in the x-axis, graph 616 depicts the acceleration data in the y-axis, and graph 618 depicts the acceleration data in the z-axis under the first test condition. The second test condition involves the user performing an operation using an abrasive device that includes an unbalanced 4-inch thin abrasive wheel. Graph 620 depicts the acceleration data in the x-axis, graph 622 depicts the acceleration data in the y-axis, and graph 624 depicts the acceleration data in the z-axis under the second test condition.

In an embodiment, an indication that the disk of the abrasive tool is unbalanced may be extrapolated from the acceleration data depicted in the graphs 602-612 and/or graphs 614-624. In particular, when operating the abrasive tool with an unbalanced wheel, the acceleration data in the y-axis includes a significant signal variation in comparison to the acceleration data in the y-axis when operating the abrasive tool under normal conditions. Accordingly, detecting significant signal variation in the acceleration data in the y-axis, perhaps in comparison to normal operations of the abrasive tool may be indicative that a wheel is unbalanced.

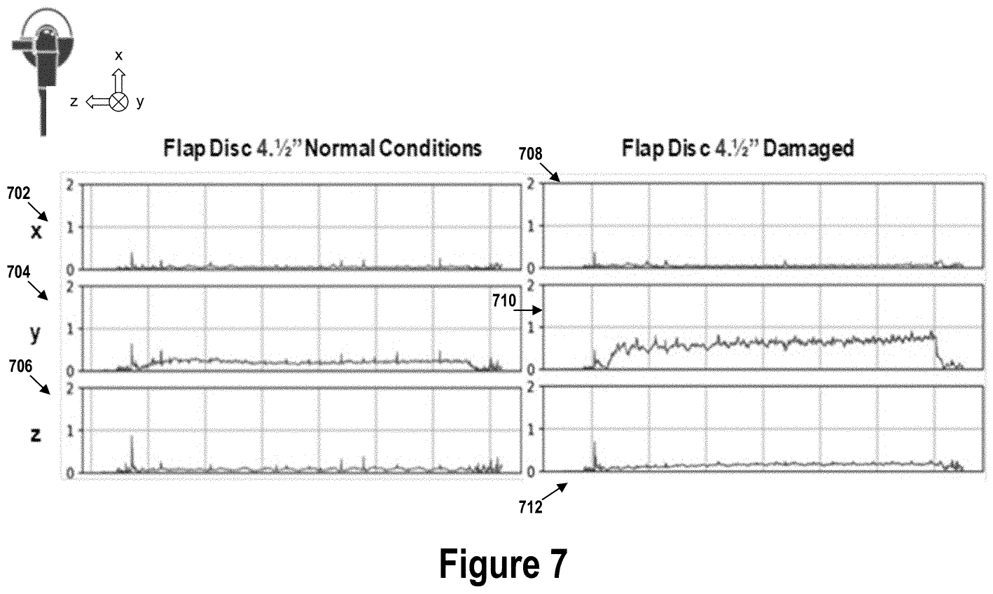

FIG. 7 illustrates graphs 702, 704, 706, 708, 710, and 712, according to an example embodiment. Each of the graphs depicts a vibration signal of a respective axis measured by a wearable device worn by a user that is using an abrasive tool that includes a 4.5 inch thin abrasive flap disk under two testing conditions. The first test condition involves the user performing an operation under normal conditions using the abrasive device. Graph 702 depicts the vibration data in the x-axis, graph 704 depicts the vibration data in the y-axis, and graph 706 depicts the vibration data in the z-axis under the first test condition. The second test condition involves the user performing an operation using an abrasive device that includes a damaged (e.g., worn) 4.5 inch abrasive flap disk. Graph 708 depicts the vibration data in the x-axis, graph 710 depicts the vibration data in the y-axis, and graph 712 depicts the vibration data in the z-axis under the second test condition.

In an embodiment, an indication that the disk of the abrasive tool is damaged may be extrapolated from the vibration data depicted in the graphs 702-712. In particular, when operating the abrasive tool with a flap disk, the vibration data in the y-axis includes a significant signal variation in comparison to the vibration data in the y-axis when operating the abrasive tool under normal conditions. Accordingly, detecting significant signal variation in the vibration data in the y-axis, perhaps in comparison to normal operations of the abrasive tool may be indicative that a flap disk is damaged.

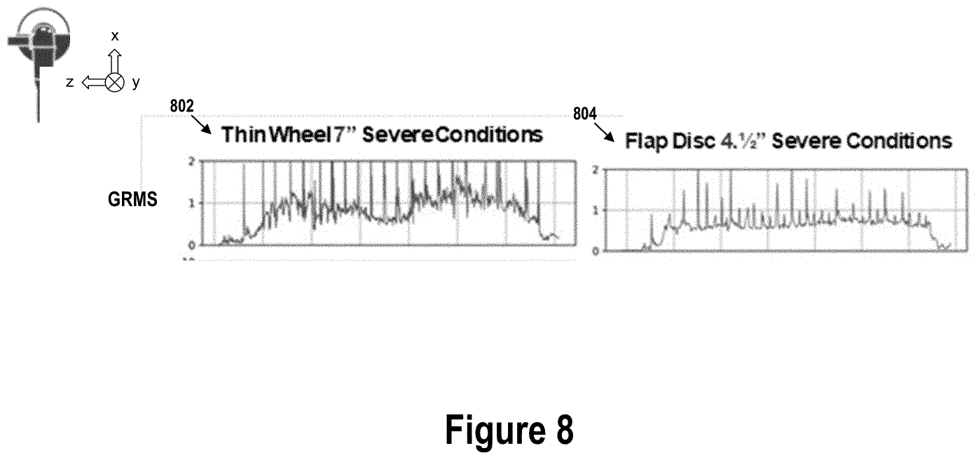

FIG. 8 illustrates graphs 802 and 804, according to an example embodiment. Graph 802 depicts a vibration signal calculated from acceleration data measured by a wearable device worn by a user that is using an abrasive tool that includes a 7 inch thin abrasive flap disk under severe conditions. Graph 804 depicts a vibration signal calculated from acceleration data measured by a wearable device worn by a user that is using an abrasive tool that includes a 4.5 inch thin abrasive flap disk under severe conditions. In an embodiment, the peaks in the vibration data may be used to determine the shocks and strokes experienced by the abrasive tool. Accordingly, detecting peaks in the vibration data, perhaps greater than a threshold, may be indicative of the shocks and strokes experienced by the abrasive tool.

In addition to using the abrasive operational data to determine real-time feedback and/or notifications related to the abrasive operations, the wearable device 202 and/or the remote server 216 may store the collected data and/or the determined abrasive operational data in a data storage device. Specifically, the collected data and/or the abrasive operational data that corresponds to a particular task may be stored in the data storage device after the task has been performed. Additionally, the stored data may include metrics indicative of a performance of the task, such as the employee that performed the task, timing of the task, feedback on the task (e.g., from a manger or customer), vibration, noise, productivity, product life, etc. The stored data may be categorized based on a type of the tool 206 used in the task, a date of performing the task, a user that performed the task, a length of the task; and/or a type of workpiece associated with the task.

In an embodiment, the wearable device 202 and/or the remote server may analyze the stored data (also referred to herein as “historical data”). In one implementation, based on the analysis of the stored data, the wearable device 202 and/or the remote server may determine operation and/or enterprise improvements. The operation and/or enterprise improvements may involve implementing workflows and/or best practices for performing a particular type of task. Additionally and/or alternatively, the operation and/or enterprise improvements may include information resources such as knowledge base articles that include information related to tasks, information related to best practices when performing tasks, and information describing how to use certain tools.

In another implementation, the wearable device 202 and/or the remote server 216 may analyze the data to determine different metrics associated with the tool 206 and/or the components of the tool 206. The metrics may include a usage rate, a total operation time, number of malfunctions, number of repair requests, a life length (e.g., of the abrasive article 208). Additionally and/or alternatively, the wearable device 202 and/or the remote server 216 may compare different metrics for different abrasive products used in a given task, perhaps across many users.

In another implementation, the wearable device 202 and/or the remote server 216 may analyze the data collected over the lifetime of many components of different specifications by different operators in order to determine correlations between product life, product specification and/or use condition. Such data could be used to provide an operator with an indication of abrasive specification and use conditions for the task that the operator is performing. For instance, based on a material of the workpiece, the wearable device 202 may provide the operator with a recommendation of abrasive specification and use conditions, which may have been determined based on an analysis of the data.

In some embodiments, the remote sensors and/or wearable devices could be configured to communicate with one or more sensors associated with the grinding product or tool. For example, the grinding tool could include an optical or magnetic sensor operable to provide information about an angular velocity (RPM) of a grinding wheel or disc. In such scenarios, remote sensors and/or the wearable devices could be configured to communicate with the grinding tool so as to associate the RPM information with the noise and/or vibration information obtained by the wearable device. Additionally or alternatively, the remote sensors and/or wearable devices could provide instructions to the grinding tool so as to adjust an operating mode of the grinding tool. For example, in some embodiments, the remote sensors and/or wearable devices could instruct the grinding tool to adjust an RPM, turn on, and/or turn off based on the noise and/or vibration information. For example, if the remote sensors and/or the wearable devices determine that the operation of the grinding tool is unsafe based on the noise and/or vibration data, the remote sensor and/or the wearable device could instruct the grinding tool to shut down. Other types of instructions are possible based on the noise and/or vibration data received by the remote sensor and/or wearable device.

### III. Additional Embodiments

i. Additional Sensors

In an embodiment, in addition to sensors embedded in a wearable device, a remote sensor may be disposed in an environment of an abrasive tool. In particular, the remote sensor could be utilized for obtaining real-time noise and/or vibration data from a grinding operation. The remote sensor could be configured to detect sounds and/or movements relating to grinding and/or cutting operations. The remote sensor could be positioned in various locations with respect to the grinding/cutting tool and the workpiece. For instance, a vibration sensor, gyroscope, microphone, and/or any other sensor may be embedded within the tool or a handle of the tool. In some embodiments, the remote sensor could be located nearby the tool and/or workpiece. In other embodiments, the remote sensor could be mounted on a work surface on which the workpiece may lay. In yet other embodiments, the remote sensor could be mounted at a wall or ceiling location. It will be understood that multiple remote sensors could be located at various locations nearby a tool and/or workpiece to provide “stereo” or multi-sensor combinations. Such multiple sensor combinations could provide information on which tool is being used and/or disambiguate particular sounds based on stereoscopic or multiscopic sensing. The remote sensors may be battery powered or may have an internal energy harvesting mechanism (e.g., a photovoltaic energy harvesting system or a piezoelectric energy harvesting system) to make them “self powered”.

The remote sensor(s) include a communication interface. In some examples, the communication interface could be configured to transmit audio data, vibration data, or other data to a wearable device, which in turn can transmit the data to a cloud computing device. In some examples, the communication interface could be configured to transmit audio data, vibration data, or other data directly to a cloud computing device. In some examples, the communication interface could be configured to transmit audio data, vibration data, or other data directly to intermediate computing device (e.g., an on premise computing device), which in turn can transmit the data to a cloud computing device. Other possibilities are also contemplated.

The communication interface could include wireless network receivers and/or transceivers, such as a Bluetooth transceiver, a ZigBee transceiver, a Wi-Fi transceiver, a WiMAX transceiver, a Zeewave transceiver, a wireless wide-area network (WWAN) transceiver and/or other similar types of wireless transceivers configurable to communicate via a wireless network. Other types of communication interfaces are contemplated.

In some embodiments, the remote sensors and/or wearable devices could be configured to communicate with one or more sensors associated with the grinding product or tool. For example, the grinding tool could include an optical or magnetic sensor operable to provide information about an angular velocity (RPM) of a grinding wheel or disc. In such scenarios, remote sensors and/or the wearable devices could be configured to communicate with the grinding tool so as to associate the RPM information with the noise and/or vibration information obtained by the wearable device. Additionally or alternatively, the remote sensors and/or wearable devices could provide instructions to the grinding tool so as to adjust an operating mode of the grinding tool. For example, in some embodiments, the remote sensors and/or wearable devices could instruct the grinding tool to adjust an RPM, turn on, and/or turn off based on the noise and/or vibration information. For example, if the remote sensors and/or the wearable devices determine that the operation of the grinding tool is unsafe based on the noise and/or vibration data, the remote sensor and/or the wearable device could instruct the grinding tool to shut down. For example, systems and methods described herein could include a remote switch that could automatically turn off the tool. Turning off the tool could be performed remotely based on determining an unsafe condition, determining a worn abrasive product, determining that the abrasive tool is reaching an end of its useful life, etc. Other types of instructions are possible based on the noise and/or vibration data received by the remote sensor and/or wearable device.

In some embodiments, the grinding tool, grinding wheel or disc, and/or the wearable device can include a tag, which could be a quick response (QR) code, bar code, a radio-frequency identification (RFID) tag (both active and passive), a near field communication (NFC) tag, a BLUETOOTH LOW ENERGY (BLE) tag, or another type of tag. In examples, the tag may contain information about the grinding tool, grinding wheel or disc, and/or the wearable device and/or may include a unique identifier, such as a universally unique identifier (UUID), which could be used as a pointer reference. The pointer reference could direct a computing device to information regarding the grinding tool, grinding wheel or disc, and/or the wearable device that is stored on a database server or elsewhere. This information may include, for example, process data, such a vibration and RPM data, captured by the remote sensors and/or wearable devices.

To obtain information from the tag, a reader may be used. The reader may communicate with the tag over RFID, NFC, and/or BLE communications over ultra high (e.g., at or near 900 megahertz), high (e.g., at or near 14 megahertz), or low (e.g., at or near 130 kilohertz) frequencies. The physical distance during communication between the tag and reader may vary based on the frequency and type of the communication medium. The data received by the reader may be information related to the grinding tool, grinding wheel or disc, and/or the wearable device and/or a unique identifier of the grinding tool, grinding wheel or disc, and/or the wearable device.

In some embodiments, the reader may take on the form of a portable, standalone reader system. In some embodiments, the reader may take on the form of a device physically connected to the wearable device or grinding tool. In some embodiments, the reader can be embedded into a circuit of the wearable device. The reader may transmit information received from the tag, perhaps to a cloud computing device, via USB connections, micro USB connections, or similar physical connection mechanisms, or wireless protocols, such as Bluetooth or Wi-Fi.

ii. Cloud Computing Devices, Mobile Devices, and Storage

The systems and methods described herein could include a plurality of remote sensors and/or wearable devices that could be communicatively coupled to one or more a web service, server, or cloud computing devices. In some embodiments, the remote sensors and/or wearable devices could be operable to run web applications, which could include event-driven scripts operating in a Node.js (e.g., JavaScript everywhere) runtime environment, among other possibilities. Namely, the remote sensors and/or wearable devices could be configured to communicate with the cloud computing devices in a real-time and/or asynchronous fashion. In an example embodiment, the application data detected and/or generated by the remote sensors and/or wearable devices could be synchronized across client devices and/or cloud computing devices by way of real-time database and storage software, such as Firebase. In some embodiments, the remote sensors and/or the wearable device could be configured to communicate with the remote computing device using Message Queuing Telemetry Transport (MQTT) or another type of messaging protocol. Other software services and/or communication protocols are possible and contemplated herein.

In some embodiments, the remote sensors, wearable devices, and/or cloud computing devices above can communicate with a mobile device. The mobile device could include a smartphone, tablet, laptop computer, or another type of computing device. Even further, the mobile device could include, for example, a head-mountable display (HMD), a heads-up display (HUD), or another type of portable computing device with or without a user interface.

A mobile application may operate on the mobile device. The mobile application can be configured with authentication mechanisms, which may include a passcode, two-factor authentication, fingerprint identification, facial recognition, or verification of other biometric information. Such authentication mechanisms may provide varying levels or types of user access. Based on the present user's level of access, the mobile application may display a different arrangement of information, provide access to different types of information, and/or offer varying functionality.

Information displayed on the mobile application may include information collected by the remote sensors and/or wearable devices (e.g., RPM information, vibration information), maintenance information indicting the condition of the remote sensor and/or wearable devices, and so on. The mobile application could also contain selectable options to perform actions. The actions could include methods that allow users to reorder a damaged or malfunctioning abrasive article. For example, the mobile application may receive an analysis of sensor data from server 216 (or may perform an analysis of sensor data received from the remote sensor and/or wearable devices). Based on the analysis, the mobile application may provide a graphical interface that allows a user to request a replacement abrasive article. Upon the user selecting a replacement from the graphical interface, the mobile application could forward the request to the cloud computing devices, for example.

In some embodiments, data from the plurality of remote sensors and/or wearable devices could be stored in a non-volatile form of memory storage such that data can be obtained without network communication (e.g., “offline”). For example, wearable device 202 may be equipped with a removable Secure Digital® (SD) memory card that can store data related to the operations of the plurality of remote sensors and/or wearable device 202.

iii. Machine Learning

In an embodiment, the cloud computing device or the wearable device could utilize machine learning to process and/or analyze the sensor data collected by the wearable device and/or the remote sensors. In an implementation, the cloud computing device may use an unsupervised learning algorithm to determine baseline patterns for the vibration and/or noise data. The algorithm may then detect a variation from the baseline patterns. Once the variation is detected, the algorithm may extrapolate the operational parameter of the abrasive tool, as described above.

In another implementation, the cloud computing device could utilize machine learning to process and/or analyze the sensor data collected by the wearable device and/or the remote sensors. In an implementation, the cloud computing device may use unsupervised learning to determine baseline patterns for the vibration and/or noise data. The algorithm may then detect a variation from the baseline patterns. Once the variation is detected, the computing device may extrapolate the operational parameter of the abrasive tool, as described above.

In yet another embodiment, the cloud computing device could utilize machine learning to correlate the data with at least one of: a grinding operation mode, a particular workpiece, a particular tool, or a particular grinding condition. In response to correlating the data with one or more operational modes, workpieces, tools, and/or grinding conditions, the cloud computing device could provide an output, which could include an alarm, an alert, a notification, and/or a report.

In further embodiments, the machine learning model could be trained using a supervised or semi-supervised machine learning approach. For example, during a training phase, the cloud computing device could be configured to accept tagged or labeled data as input. In such a scenario, the labeled data could include acceleration data under known conditions (e.g., wheel type, operating conditions, tool type, etc.), such as illustrated and described with reference to FIGS. 4, 5, 6A, 6B, 7 and 8. The labels could include one or more known conditions of each data entry. The cloud computing device could utilize the labeled data to adjust weights and/or other parameters of, for example, a classifier model or a recommender model. Such models could be implemented using, for example, a logistic or linear regression, a support vector machine (SVM), a Bayes network, among other possibilities. Models that incorporate rule-based algorithms (e.g., association rule models, learning classifier models, etc.) are also contemplated and possible within the scope of the present application.

The training phase could include, for example, evaluating how well the given model predicts an outcome given the labeled data as input. For example, the training phase could include determining a loss function based on a difference between the predicted outcome and the labeled outcome. Various optimization algorithms are possible, including maximum likelihood estimation (MLE) or other fitting algorithms.

In some embodiments, prior real-time data could be labeled and be utilized during a subsequent training phase to further improve the machine learning model. In yet further embodiments, prior real-time data could be correlated with measurements of the workpiece (e.g., smoothness, material removal depth, etc.). In such scenarios, a reinforcement learning approach could be used to improve the machine learning model by maximizing an expected reward (e.g., workpiece surface smoothness, appropriate material removal, etc.).

After the model has been trained during the training phase, the machine learning model could be applied at run-time to predict or infer a condition based on the real-time data received by a sensor (e.g., an acceleration sensor mounted on the body mountable device illustrated and described in reference to FIG. 2). As described herein, the predicted condition could trigger, prompt, or initiate various events such as a notification, a report, an order, or another type of action.

iv. Systems and Methods of Calculation

As previously discussed, an abrasive product/tool can include sensors that detect an angular velocity (RPM) of a grinding wheel or disc. Wearable device 202 can communicate with these sensors to receive RPM information and determine a grinding power and/or applied grinding force of the abrasive product/tool. Additionally and/or alternatively, wearable device 202 may use sound data to determine the RPM of a grinding wheel or disc. In particular, wearable device 202 may analyze an amplitude of the sound data and then use a correlation table to map the sound amplitude to an estimated RPM value. The mapping between the sound amplitude and the estimated RPM value may vary depending on the type of abrasive product/tool.

In either of the above scenarios, wearable device 202 relies on communication with sensors or the type of abrasive product/tool (e.g., for the mapping) to determine RPM information. Yet it may be advantageous to decouple the reliance of wearable device 202 from the abrasive product/tool. Doing so, for example, may allow wearable device 202 to determine RPM for any grinding wheel or disc, independent of the how the abrasive product/tool is being held by the user of wearable device 202, regardless of the type of abrasive product/tool being held, and regardless if any communication sensors are present on the abrasive product/tool.

To independently determine RPM, a vibration signal may be used. In particular, the vibration signal may be determined from an accelerometer of wearable device 202. As noted above, the accelerometer collects acceleration data related to vibration of the user's hand. Because the hand's vibration results from the abrasive product/tool's vibration, the acceleration data indicates the vibration of the abrasive product/tool. The acceleration data may then be used to calculate a gRMS value over time, resulting in a vibration signal. Notably, the calculation of gRMS could be performed on wearable device 202, on a remote device such as the aforementioned cloud computing devices, or partially on wearable device 202 and partially on a remote device.

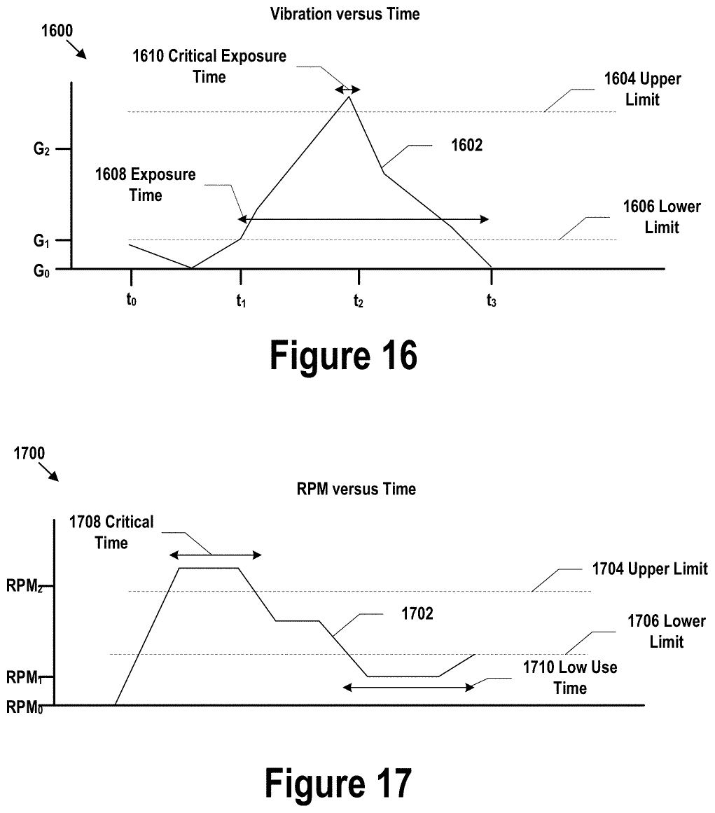

FIG. 16 illustrates graph 1600, according to an example embodiment. As illustrates in FIG. 16, graph 1600 includes signal 1602, which represents the vibration of wearable device 202 over time. Namely, signal 1602 results from the vibration experienced by a user when wearing wearable device 202 and using an abrasive product/tool. The x-axis of graph 1600 corresponds to time values, while the y-axis corresponds to vibration values (in gRMS).

An important point to recognize is that since the RPM of a grinding wheel or disc contributes to the signal 1602, a Fourier transformation (e.g., Fast Fourier transformation (FFT), short-time Fourier transform (STFT), etc.) can be performed on signal 1602 to determine the RPM value. For example, software embedded on wearable device 202 can perform a Fourier transformation on signal 1602 from the time period between t0 and t3 to determine the RPM of the grinding wheel or disc from t0 to t3.

In some embodiments, the RPM of the grinding wheel of disc may vary over time. For example, a user can push a grinding wheel or disc harder into a workpiece (the friction of the workpiece thereby slowing the rotational speed), the power levels of the abrasive device/tool can change, and so on. To account for this, signal 1602 may be divided/sampled into shorter segments and then software embedded on wearable device 202 can compute the Fourier transformations on each shorter segment. For example, a Fourier transformation on signal 1602 can be performed from the time period between t0 and t1, from a time period between t1 and t2, and so on. The RPM for each time segment may be plotted to determine a graph of RPM over time (as shown in FIG. 17).

In some embodiments, signal 1602 may be composed of multiple underlying frequencies and/or may have confounding/alias frequencies. To determine the exact frequency that corresponds to the RPM of the grinding wheel or disc, a frequency with the highest amplitude or a frequency with an amplitude within a predetermined range may be used. Alternatively, in scenarios in which signal 1602 is divided into shorter segments, the RPM for a given time segment may be determined based on a frequency with an amplitude that shows little deviation from a previous time segment. Other methods are also possible.

In some embodiments, signal 1602 represents the vibration of wearable device 202 with respect to a given axis (e.g., the accelerometer may be operable to measure and record vibration data in three axes (x, y, and z)). In these situations, a vibration signal may be determined for each axis and an aggregate/composite vibration signal for the grinding wheel or disc may be determined by weighting/combining the individual vibration signals for each axis. In some examples, the weighting/combining may be based on an occupational safety standard, such as the ISO 5349 standard discussed herein. To illustrate, applying the ISO 5349 standard may involve combining the vibration signal from each axis by way of a root mean squared calculation, where each axis is weighted differently in the composite vibration signal. However, other occupational safety standards and their corresponding algorithms for determining the aggregate/composite vibration signals are also contemplated herein. Wearable device 202 could be configured to carry out those algorithms additionally and/or alternatively to the ISO 5349 standard.

As shown in FIG. 16, limits may be placed on the signal 1602. More specifically, upper limit 1604 and lower limit 1606 may be used to represent upper and lower limits of vibration, with the region between upper limit 1604 and lower limit 1606 being an “optimal zone” of vibration for the abrasive product/tool. In some embodiments, upper limit 1604 and lower limit 1606 may be determined by the manufacturer of wearable device 202 or the manufacturer of the abrasive product/tool. In other embodiments, upper limit 1604 and lower limit 1606 may be based on an occupational safety standard, either enforced today or in the future. For example, upper limit 1604 and lower limit 1606 may be based on standards set by the Occupational Safety and Health Administration (OSHA), the National Institute for Occupational Safety and Health (NIOSH), the European Agency for Safety and Health at Work (EU-OSHA), or the International Organization for Standardization (ISO). In some cases, upper limit 1604 and lower limit 1606 may be based on the ISO 5349 exposure risks.

In some embodiments, upper limit 1604 and lower limit 1606 can be determined based on values installed into the firmware of wearable device 202 upon manufacturing or user defined values that are dynamically loaded into the firmware of wearable device 202. In examples, user defined values can be communicated to wearable device 202 via a user interface component of wearable device 202, can be communicated to wearable device 202 via a web application, such as the web applications described below, or communicated to wearable device 202 from a cloud computing device, such as the cloud computing devices described above. Other possibilities also exist.

Since keeping the vibration of the abrasive product/tool within the optimal zone can be valuable to the user, wearable device 202 may determine deviations from the optimal zone. For example, wearable device 202 may determine exposure time 1608, which corresponds to a length of time which vibrations are in the optimal zone. Exposure time 1608 can be compared to a total time of operation (e.g., t3-t0) to determine the percentage of time within the optimal zone. If the percentage of time within the optimal zone is sufficiently low, wearable device 202 can provide information to increase the percentage of time, perhaps by outputting a visual, haptic, and/or audio alert that provides operational improvements, recommended angles of operation, and so on.

As another example, wearable device 202 can determine critical exposure time 1610, which represents a period of vibration above upper limit 1604. Since operations in excess of critical exposure time 1610 could be detrimental to users, wearable device 202 can provide information to decrease critical exposure time 1610, perhaps by outputting a visual, haptic, and/or audio alert as similarly described above.

Further, patterns discovered on signal 1602 can be indicative of operational statuses shown in table 300. For example, wearable device 202 may determine that an operational status of the abrasive tool is “sanding with a worn” if critical exposure time 1610 is greater than N seconds (N=1, 2, 10s). Other operational statuses are also possible.

FIG. 17 illustrates graph 1700, according to an example embodiment. As illustrated in FIG. 17, graph 1700 includes signal 1702, which may represent the RPM of a grinding wheel or disc over time. Namely, signal 1702 may result from a Fourier transformation performed on signal 1602 from graph 1600. The x-axis of graph 1700 corresponds to a time value, while the y-axis corresponds to a RPM value (in gRMS).

Similarly to graph 1600, graph 1700 contains upper limit 1704 and lower limit 1706, respectively representing the upper and lower limits of RPM, The region between upper limit 1704 and lower limit 1706 is an “optimal zone” of RPM for the grinding wheel or disc. In some embodiments, upper limit 1704 and lower limit 1706 may be determined by the manufacturer of wearable device 202 or the manufacturer of the abrasive product/tool. In other embodiments, upper limit 1704 and lower limit 1706 may be based on occupational safety standards, either enforced today or in the future.

In some embodiments, upper limit 1704 and lower limit 1706 can be determined based on values installed into the firmware of wearable device 202 upon manufacturing or user defined values that are dynamically loaded into the firmware of wearable device 202. In examples, user defined values can be communicated to wearable device 202 via a user interface component of wearable device 202, can be communicated to wearable device 202 via a web application, such as the web applications described below, or communicated to wearable device 202 from a cloud computing device, such as the cloud computing devices described above. Other possibilities also exist.

Much like graph 1600, keeping the RPM within the optimal zone of graph 1700 can be valuable to the user. Thus, wearable device 202 may operate to determine deviations of RPM from the optimal zone. For example, wearable device 202 may determine critical time 1708, which corresponds to a length of time for which RPM was above upper limit 1704. Likewise, wearable device 202 may operate to determine low use time 1710, which corresponds to a length of time for which RPM was below lower limit 1706. In either case, wearable device 202 can provide information to decrease critical time 1708 and low use time 1710, perhaps by outputting a visual, haptic, and/or audio alert that provides operational improvements, recommended angles of operation, and so on.

In some embodiments, data from graph 1600 and/or graph 1700 may be transmitted by wearable device 202 to a cloud computing device for storage and additional computation. For example, the cloud computing device can execute the machine learning algorithms discussed above to discover patterns (e.g., grinding time, optimal RPM time, overload time, optimum vibration time, etc.) with regard to signal 1602 and/or signal 1702. Discovered patterns can then be transmitted to a web application that provides information to the user. Additionally and/or alternatively, the web application may include of plots of the vibration of wearable device 202 over time (e.g., graph 1600) and/or may include of plots of the RPM of wearable device 202 over time (e.g., graph 1700) The web application may be auto-scalable—capable of being viewed on a tablet device, desktop computing device, mobile device, and so on. Further, the web application may be configured to establish dedicated accounts for various users and may have security measures in place to isolate each user's data and ensure privacy. In some embodiments, the cloud computing device or web application can be used to update the firmware of wearable device 202, for example, by transmitting software updates to communication interface 106 of wearable device 202.

Notably, while the embodiments above are discussed with regard to vibration and RPM data, other types of data are also contemplated in the disclosure herein.

In one example, temperature sensors/relative humidity sensors may be used to provide data about environment temperatures and humidity levels around wearable device 202. In turn, the data collected by the temperature sensors/relative humidity sensors may be used to measure thermal exposure times for an abrasive product/tool being operated on by the user of the wearable device 202. For instance, the temperature sensors/relative humidity sensors may calculate that an abrasive product/tool operated in a 55° F. environment for 2 flours and then operated in a 105° F. environment for 6 hours. The calculated thermal exposure times could then be used to determine the remaining product life/productivity for the abrasive product/tool. For instance, if the abrasive product/tool frequently operated in a high temperature environment, then the projected product life of the abrasive product/tool may shorter than if the abrasive product/tool frequently operated in a moderate temperature environment.

In another example, magnetometers may be used to provide data about surrounding magnetic fields/orientations of wearable device 202 or workpieces operated on by the user of wearable device 202.

In yet another example, capacitance sensors may used to provide data about material density or potential damages related to wearable device 202 or abrasive tools.

In a further example, current measurements may be obtained from abrasive tools and converted into power data. The power data be used to provide grinding cycle data for the abrasive tools and, in some cases, may be compared with the aforementioned vibration and RPM data to gain further insights on an abrasive operation. Moreover, the data described above data, along with data from other sensors such as inertial sensors, pressure sensors, and/or force sensors may be graphed, transformed, displayed on a dashboard, such as displays 2100, 2110, 2120, and 2130 described below, and associated with upper and lower threshold limits as similarly described with respect to graph 1600 and graph 1700.

v. Other Systems

The embodiments described in FIGS. 16 and 17 provide methods to capture the RPM of a grinding wheel or disc. These methods generally determine RPM from the vibration of wearable device 202. In particular, an accelerometer on wearable device 202 collects acceleration data related to vibration of the user's hand. The vibration of the hand occurs from the vibration of an abrasive product/tool. However, in some situations, it may be impractical or even impossible for a user's hand to wear wearable device 202 and operate an abrasive product/tool. For example, an abrasive product/tool may not have a handle for a hand to grasp. Or, the abrasive product/tool may be too dangerous for a hand to operate. But even in these situations, it may still be of interest to determine RPM data from the vibration of wearable device 202.

Attempts to determine RPM from vibration data without a user's hand introduce a number of disadvantages. For example, approaches that simply attach wearable device 202 to the handle of an abrasive tool (e.g., strapping wearable device 202 onto handle 212) or embed a vibration sensor into the abrasive product/tool fail to discriminate RPM from the vibration signal because these approaches introduce noise into the vibration signal.

To address this and perhaps other issues, the embodiments herein present systems and methods to mimic physiological properties of the human hand. In particular, an auxiliary component between wearable device 202 and an abrasive tool is presented. The auxiliary component may be constructed with properties innate to the physiology of the human hand (e.g., the hand that wearable device 202 is attached to). These properties allow the auxiliary component to filter out the noise and enable discrimination of RPM from the vibration signal.

Additionally, the auxiliary component may allow wearable device 202 be in compliance with the ISO 5349 standard. As mentioned above, ISO 5349 is a standard for measurement and evaluation of human exposure to hand-transmitted vibration. In particular, ISO 5349 stipulates that measurements of hand-transmitted vibration should be made by a sensor positioned between a user's hand and a vibrating device (e.g., in the palm of the user's hand as they hold the vibrating device). If wearable device 202 is in the form of a wrist-mountable device as shown in FIG. 2, then wearable device 202 may be uncompliant with the standard. However, using the auxiliary component described herein, wearable device 202 can adhere to the standard.

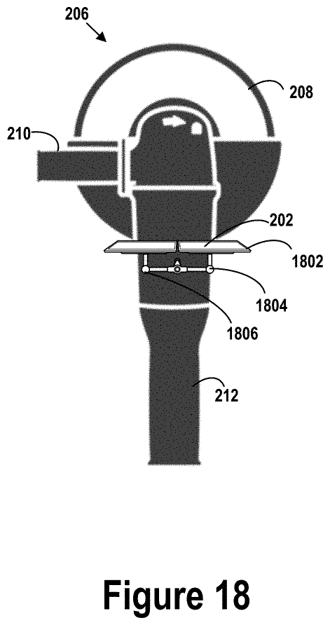

FIG. 18 illustrates components of a system, according to example embodiments. Notably, FIG. 18 illustrates abrasive tool 206, which includes abrasive article 208, handle 210, and handle 212. Additionally, FIG. 18 shows that auxiliary component 1802 is attached to abrasive tool 206. Auxiliary component 1802 may include wearable device 202 or alternatively may include a standalone vibration sensor to detect the RPM of abrasive article 208.

In some embodiments, auxiliary component 1802 may have similar degrees of freedom to that of a human hand. Put differently, auxiliary component 1802 may include joints 1804 and joint 1806, which together allow auxiliary component 1802 to experience vibrations in multiple directions. For example, joint 1804 may allow auxiliary component 1802 to experience vibrations along a y-axis, joint 1806 may allow auxiliary component 1802 to experience vibrations along the z-axis. This allows auxiliary component 1802 to vibrate in directions not normally enabled by simply attaching a wearable device 202 or a standalone vibration sensor to abrasive tool 206.

In some embodiments, auxiliary component 1802 may be formed of a material with similar viscoelastic properties to that of a human arm. For example, auxiliary component 1802 may be constructed from latex, rubber, silicon and/or a polymeric material. These viscoelastic properties may also allow auxiliary component 1802 to vibrate in directions not normally enabled by simply attaching a wearable device 202 or a standalone vibration sensor to abrasive tool 206.

vi. Example Web Applications and Data Models

As described above, a web application may be configured to display information about remote sensors, wearable devices, abrasive tools, abrasive tool operators, and so on. This may be accomplished by way of a web page or series of web pages hosted by a cloud computing device and provided to users upon request. The layout and compilation of information in these web pages may enable efficient review of pertinent information about the remote sensors, wearable devices, abrasive tools, abrasive tool operators, and so on. Additionally, the web pages may organize and arrange the information using graphics with intuitive visuals and easy to understand metrics.

As an additional feature, the web application may allow users to make associations between abrasive tools, wearable devices, abrasive tool operators, and plants (e.g., an environment in which abrasive operations are being performed). For example, a user may associate plant P1 with abrasive tool AT1 to indicate that abrasive tool AT1 is operating within plant P1. The user may then associate abrasive tool AT1 with wearable device WD2 to indicate that the data collected by wearable device WD2 is with respect to the operations of abrasive tool AT1. Finally, the user may associate wearable device WD1 with operator O1 to indicate that operator O1 is wearing wearable device WD1. In this way, abrasive tools, wearable devices, abrasive tool operators, and plants become distinct logical entities on the web application which can be mixed in matched with each other.

Having distinct logical entities may have numerous benefits. For example, suppose that wearable device WD1 was permanently associated with operator O1. If operator O1 suddenly became unavailable, then no data could be collected from wearable device WD1 during the unavailability. On the other hand, suppose that wearable device WD1 was a distinct logical entity from operator O1. If operator O1 became unavailable, then wearable device WD1 could quickly be associated with operator O3 and data could still be collected for wearable device WD1. Advantageously, data can be collected from wearable device WD1 regardless of operator O1 or operator O3. Other advantages are also possible.

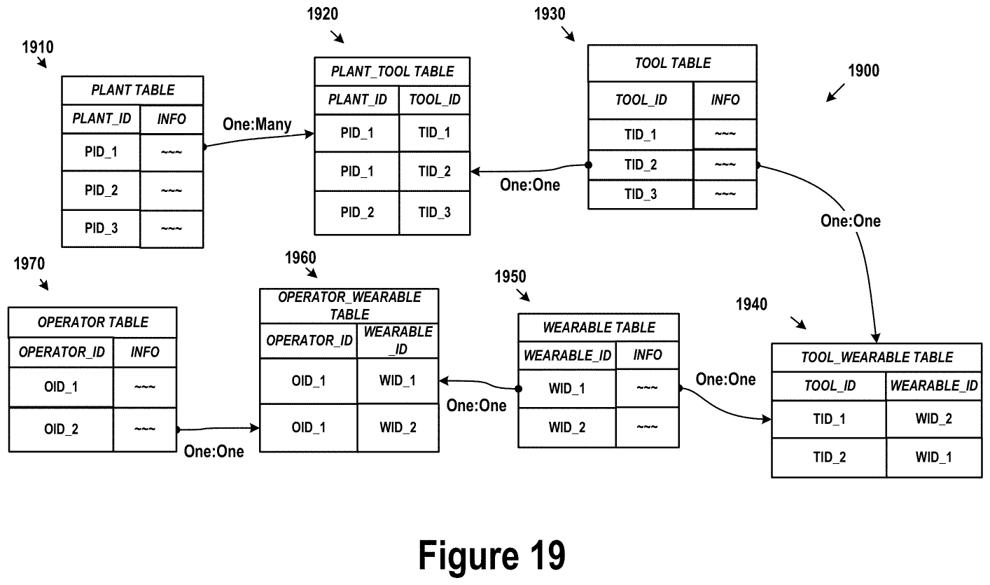

FIG. 19 illustrates model 1900, in accordance with example embodiments. Model 1900 may include four base tables—plant table 1910, tool table 1930, wearable table 1950, and operator table 1950—and three linking tables—plant tool table 1920, tool wearable table 1940, and operator wearable table 1960. As a unit, these tables provide the necessary information to capture the relationships between plants, abrasive tools, wearable devices, and operators. In some examples, model 1900 can have more, fewer, and/or different types of tables than indicated in FIG. 19. Moreover, the tables in model 1900 may be abridged for the purposes of clarity. But in practice, these tables may contain more, fewer, and/or different entries.

Plant table 1910 can include entries for plants. In particular, each entry in plant table 1910 may have a unique identifier for a plant and associated information for the plant. In some examples, a user may input, for example through a web page or series of web pages provided by a cloud computing device, the information to populate plant table 1910.

Plant tool table 1920 can include entries that map a given plant from plant table 1910 to an abrasive tool from tool table 1930 that operates in the given plant. In particular, the web application described above may provide means for dynamically populating the entries in plant tools table 1920. For example, the web application may provide a series of dropdown menus to allow users to make associations between plants and abrasive tools that operate within those plants.

Tool table 1930 can include entries for abrasive tools, such as abrasive tool 206. In particular, each entry in tool table 1930 may have a unique identifier for an abrasive tool and associated information for the abrasive tool. In some examples, a user may input, for example through a web page or series of web pages provided by a cloud computing device, the information to populate tool table 1930. In other examples, the information in tool table 1930 can be populated from the remote sensors and/or wearable devices as described above.

Tool wearable table 1940 can include entries that map an abrasive tool from tool table 1930 to a wearable from wearable table 1950 that collects data associated with that abrasive tool. In particular, the web application described above may provide means for dynamically populating the entries in tool wearable table 1940. For example, the web application may provide a series of dropdown menus to allow users to make associations between abrasive tools and wearable devices. In some cases, entries in tool wearable table 1940 can be automatically populated through the readers as described above. For example, an abrasive tool may include an RFID tag, such as identifying feature 218, and a wearable device may include an RFID reader that can read the RFID tag of the abrasive tool to associate the wearable device with the abrasive tool.

Wearable table 1950 can include entries for wearable devices, such as wearable device 202. In particular, each entry in wearable table 1950 may have a unique identifier for a wearable device and associated information for the wearable device. In some examples, a user may input, for example through a web page or series of web pages provided by a cloud computing device, the information to populate wearable table 1950. In other examples, the information in wearable table 1950 can be populated from the remote sensors as described above.

Operator wearable table 1960 can include entries that map a wearable device from wearable table 1950 to an operator from operator table 1970 that wears the wearable device. In particular, the web application described above may provide means for dynamically populating the entries in operator wearable table 1960. For example, the web application may provide a series of dropdown menus to allow users to make associations between wearable devices and operators. In some cases, entries in operator wearable table 1960 can be automatically populated through the readers as described above. For example, a wearable device may include an RFID tag and an operator may have an RFID reader that can read the RFID tag of the wearable device to associate the wearable device with the operator.

Operator table 1970 can include entries for operators that wear wearable devices. In particular, each entry in operator table 1970 may have a unique identifier for an operator and associated information for the operator. In some examples, a user may input, for example through a web page or series of web pages provided by a cloud computing device, the information to populate operator table 1970.

Taken together, the tables of model 1900 provide information to establish (i) which operators are associated with which wearable devices, (ii) which wearable deices are associated with which abrasive tools, and (iii) which abrasive tools are associated with which plants. In some cases, a web application can use this information to provide metrics related to plants, wearable devices, abrasive tools, and operators.

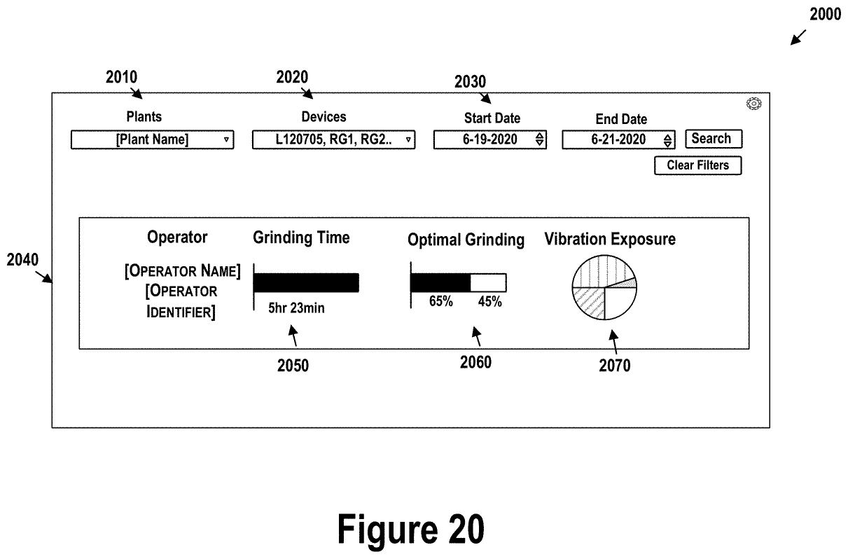

FIG. 20 illustrates web page 2000, in accordance with example embodiments. Web page 2000 may be provided to a user by the web application described above. In particular, web page 2000 provides metrics related to plants, wearable devices, abrasive tools, and operators.

As shown in FIG. 20, plant dropdown 2010 allows a user to indicate a plant from a plurality of plants range for which they want to receive metrics on. Devices dropdown 2020 allows a user to select one or more devices for which they want to receive metrics on. The devices available in devices dropdown 2020 may be based on the user's selection on plant dropdown 2010 and on the entries in plant tool table 1920. Date range 2030 allows a user to select the date range for which they want to receive metrics on. After making selections for plant dropdown 2010, devices dropdown 2020, and date range 2030, the user can continue by pressing “Search”. This action may display one or more entries corresponding to the information in the plant dropdown 2010, devices dropdown 2020, and the date range 2030 (e.g., entry 2040).

Entry 2040 includes metrics related a particular operator using a device selected from device dropdown 2020, within a plant selected from plant dropdown 2010, and during the time range selected from date range 2030. The particular operator may be determined based on entries in operator wearable table 1960, wearable table 1950, and tool wearable table 1940. Entry 2040 shows grind time metric 2050, optimal grinding metric 2060, and vibration exposure metric 2070 for the particular operator.

Grind time metric 2050 displays a bar graph of total grinding time of the particular operator during the date range 2030. In particular, grind time metric 2050 may be determined using the embodiments described with respect to graph 1600 and graph 1700.

Optimal grinding metric 2060 displays a bar graph of time spent by the particular operator while grinding within the optimal grinding parameters. In particular, optimal grinding metric 2060 may be determined using the embodiments described with respect to graph 1600 and graph 1700. While optimal grinding metric 2060 is illustrated as a bar graph, it will be understood that an amount of time or percentage or ratio of such time while grinding within optimal grinding parameters could be represented and/or displayed in a variety of different forms. For example, the optimal grinding metric 2060 could be represented as a pie chart, a radar chart, a line graph, or another type of information representation or infographic.

Vibration exposure metric 2070 displays a pie chart of vibration exposure time for the particular operator in three categories. In particular, vibration exposure metric 2070 may be determined using the embodiments described with respect to graph 1600 and graph 1700. While the vibration exposure metric 2070 is illustrated as a pie chart, it will be understood that an amount of time under respective vibration exposure conditions could be represented and/or displayed in a variety of different forms. For example, the vibration exposure metric 2070 could be represented as a bar graph, a radar chart, a line graph, or another type of information representation or infographic.

It will be understood that web page 2000 is presented for the purpose of example. In other embodiments, web page 2000 may provide other types of metrics and alternative methods of displaying such metrics.

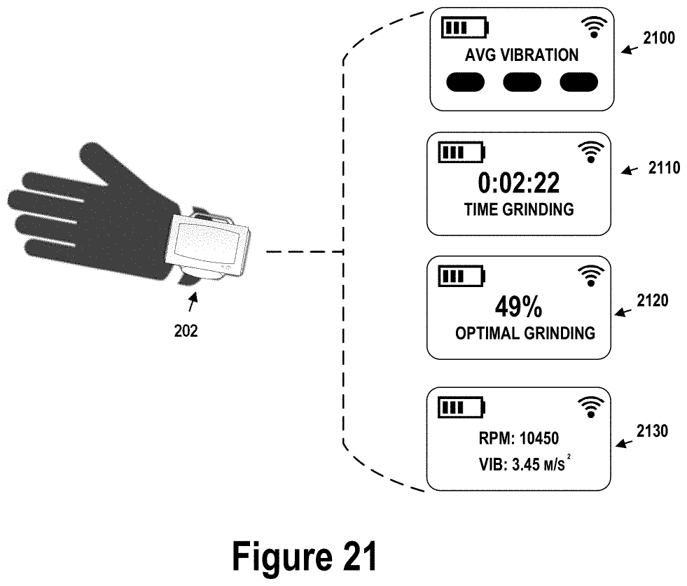

FIG. 21 illustrates displays 2100, 2110, 2120, and 2130 of wearable device 202, according to example embodiments. In particular, the displays shown in FIG. 21 illustrate different views that may appear on a user interface component of wearable device 202. However, note that the displays shown in FIG. 21 are not limiting; other displays are contemplated and possible within the scope of the present disclosure.

Display 2100 provides visual cues about the average vibration of wearable device 202, the battery life (shown at the top left), the current time (shown at the top middle), and whether a WiFi signal is present on wearable device 202 (shown at the top right).

Display 2110 also depicts the battery life, current time, and WiFi signal of wearable device 202, but additionally shows a time of grinding metric, which may be calculated, for example, using the graphs 1600 and 1700 discussed in FIGS. 16 and 17.

Display 2120 also depicts the battery life, current time, and WiFi signal of wearable device 202, but additionally shows an optimal grinding time metric, which may be calculated, for example, using the graphs 1600 and 1700 discussed in FIGS. 16 and 17.

Display 2130 also depicts the battery life, current time, and WiFi signal of wearable device 202, but additionally shows an instantaneous view of current RPM and vibration as the operator is performing abrasive operations.

vii. Example Robotic Devices

In some embodiments, the systems and devices described herein can be integrated into a robotic device. For instance, the wearable device 202 may be attached to a spindle, arm/manipulator, and/or end-effector of a robotic device, among other possible locations. Once attached, the wearable device 202 can measure vibration/noise data associated with abrasive operations performed by the robotic device, can calculate RPM information using the vibration/noise data, and could provide instructions to the robotic device so as to adjust an operating mode of the robotic device.

In an example operation, the wearable device 202 could be communicatively linked to the controller of the robotic device. The wearable device 202 could measure vibration/noise data associated with the robotic device and may responsively send feedback to the controller when it detects a deviation from baseline abrasive operations. The feedback may include an instruction to adjust the RPM currently utilized by the robotic device or to turn on/turn off the robotic device, among other instructions.

### IV. Enumerated Example Embodiments

Embodiments of the present disclosure may relate to one of the enumerated example embodiments (EEEs) listed below.

EEE 1 is a system comprising:
a sensor disposed in proximity to an abrasive product and a workpiece, wherein the sensor is configured to collect abrasion operational data associated with an abrasive operation involving the abrasive product and the workpiece;
a communication interface;
a controller comprising a memory and a processor, wherein the memory stores instructions that are executable by the processor to cause the controller to perform operations, the operations comprising:
   receiving, from the sensor, the abrasion operational data;
   determining product-specific information of the abrasive product and/or workpiece-specific information based on the abrasion operational data; and
   transmitting, via the communication interface, the product-specific information or workpiece-specific information; and
   a remote computing device configured to receive the transmitted product-specific information or workpiece-specific information.

EEE 2 is the system of EEE 1, wherein determining the product-specific information or work-specific information comprises correlating the abrasion operational data with at least one of: a material, a material removal rate, an operating condition, an expended power, or a specific grinding energy.

EEE 3 is the system as in any of EEE 1-2, wherein determining product-specific information of the abrasive product or workpiece-specific information based on the at least one of the vibration or noise data comprises:
generating at least one of vibration or noise information by sampling the at least one of the vibration or noise data, respectively, at a sample rate; and
based on the at least one of vibration or noise information, determining the product-specific information or work-specific information.

EEE 4 is the system of EEE 3, wherein the sample rate is selected based on an energy level of a battery of the sensor.

EEE 5 is the system of EEE 1, wherein the sensor is configured to collect the vibration or noise data at a sample rate, and wherein the sample rate is selected based on at least one of a data resolution or an available energy level of a battery of the sensor.

EEE 6 is the system as in any of EEEs 1-5, wherein the operations further comprise:
using the communication interface to obtain an identifier of the abrasive product; and
identifying the abrasive product using the identifier.

EEE 7 is the system of EEE 6, wherein the communication interface comprises at least one of: an image capture device, a wireless communication device, a near-field communication (NFC) device, or a radio frequency identification (RFID) reader.

EEE 8 is the system as in any of EEEs 6-7, wherein using the communication interface to obtain an identifier of the abrasive product comprises:
receiving the product identifier from the remote computing device.

EEE 9 is the system as in any of EEEs 1-8, wherein the sensor is disposed within the abrasive product or remotely from the abrasive product.

EEE 10 is the system as in any of EEEs 1-9, wherein determining product-specific information of the abrasive product or workpiece-specific information based on the at least one of the vibration or noise data comprises:
generating at least one of vibration or noise information based on the at least one of the vibration or noise data;
generating frequency data based on a frequency analysis of the at least one of the vibration or noise information; and
based on the frequency data, determining the product-specific information or work-specific information.

EEE 11 is the system of EEE 10, wherein the operations further comprise:
providing the frequency data to the remote computing device.

EEE 12 is the system as in any of EEEs 1-11, wherein the operations further comprise:
providing at least one of the vibration and/or noise data or the vibration or noise information to the remote computing device, wherein the remote computing device is further configured to analyze at least one of received vibration and/or noise data or the vibration or noise information.

EEE 13 is a computing device and a database dedicated to a computing network, wherein the computing device has access to a machine learning model that predicts characteristics of abrasive operations, and wherein the computing device is configured to perform operations, the operations comprising:
receiving vibration and noise information from a remote sensor, wherein the vibration and noise information is associated with an abrasive operation involving an abrasive product and a workpiece; and
applying the machine learning model to predict that the vibration and noise information relates to product-specific information of the abrasive product or workpiece-specific information, wherein the machine learning model was trained with mappings between: (i) operational characteristics of a plurality of prior abrasive operations involving a plurality of abrasive products and a plurality of workpieces; and (ii) surface characteristics of the workpiece during and after the prior abrasive operations.

EEE 14 is the computing device and database of EEE 13, wherein the operations further comprise storing, in the database, a configuration item related to the vibration and noise information and predicted product-specific information or workpiece-specific information.

EEE 15 is the computing device and database as in any of EEEs 1-14, wherein the operations further comprise transmitting the predicted product-specific information or workpiece-specific information to a remote computing device.

EEE 16 is a system comprising:
a body-mountable device comprising:
at least one sensor, wherein the at least one sensor is configured to detect abrasive operational data;
a communication interface; and
a controller comprising a memory and a processor, wherein the memory stores instructions that are executable by the processor to cause the controller to perform operations, the operations comprising:
receiving, from the at least one sensor, abrasive operational data associated with a specific abrasion tool or a specific abrasive product;
determining product-specific information based on the abrasive operational data; and
transmitting, via the communication interface, the product-specific information; and
a remote computing device configured to receive the transmitted product-specific information.

EEE 17 is the system of EEE 16, wherein the abrasive operational data comprises at least one of vibration or noise data, and wherein determining product-specific information of the abrasive product or workpiece-specific information based on the abrasive operational data comprises:
generating at least one of vibration or noise information by sampling the at least one of the vibration or noise data, respectively, at a sample rate; and
based on the at least one of vibration or noise information, determining the product-specific information or work-specific information.

EEE 18 is the system as in any of EEEs 16-17, wherein the sample rate is selected based on at least one of a data resolution or an available energy level of a battery of the sensor.

EEE 19 is the system as in any of EEEs 16-18, wherein the sensor is configured to collect the abrasive operational data at a sample rate, and wherein the sample rate is selected based on an energy level of a battery of the sensor.

EEE 20 is the system as in any of EEE 16-19, wherein the operations further comprise:
using the communication interface to obtain an identifier of the abrasive product; and
identifying the abrasive product using the identifier.

EEE 21 is the system as in any of EEEs 16-20, wherein the communication interface comprises at least one of: an image capture device, a wireless communication device, a near-field communication (NFC) device, or a radio frequency identification (RFID) reader.

EEE 22 is the system as in any of EEEs 16-21, wherein using the communication interface to obtain an identifier of the abrasive product comprises:
receiving the product identifier from the remote computing device.

EEE 23 is the system as in any of EEEs 16-22, wherein the sensor is disposed within the abrasive product or remotely from the abrasive product.

EEE 24 is the system as in any of EEEs 16-23, wherein determining product-specific information of the abrasive product or workpiece-specific information based on the at least one of the vibration or noise data comprises:
generating at least one of vibration or noise information based on the at least one of the vibration or noise data;
generating frequency data based on a frequency analysis of the at least one of the vibration or noise information; and
based on the frequency and/or amplitude of the data, determining the product-specific information or work-specific information.

EEE 25 is the system as in any of EEEs 16-24, wherein the operations further comprise:
providing the frequency data to the remote computing device.

EEE 26 is the system as in any of EEEs 16-25, wherein the operations further comprise:
providing at least one of the vibration and/or noise data or the vibration or noise information to the remote computing device, wherein the remote computing device is further configured to analyze at least one of received vibration and/or noise data or the vibration or noise information.

EEE 27 is the system as in any of EEEs 16-26, wherein the product-specific information comprises at least one of: an operational status, an operational duration, an idle duration, or a productive time for the specific abrasive product.

EEE 28 is the system as in any of EEEs 16-27, wherein the product-specific information comprises information indicative of an abrasion operation associated with the specific abrasive product.

EEE 29 is the system as in any of EEEs 16-28, wherein determining the product-specific information based on the at least one of the vibration or noise information comprises comparing the at least one of the vibration or noise information with a set of at least one of known vibration or noise patterns.

EEE 30 is the system as in any of EEEs 16-29, wherein the operations further comprise determining the specific abrasive product based on an identification process.

EEE 31 is the system of EEE 30, wherein the identification process comprises at least one of: a user input, a remote handshake communication process, a proximity detection process, or an optical recognition process.

EEE 32 is the system as in any of EEEs 16-31, wherein the product-specific information determined based on the vibration and noise information comprises real-time abrasion information about the specific abrasion product.

EEE 33 is the system as in any of EEEs 16-32, wherein the remote computing device comprises a cloud computing platform

EEE 34 is the system as in any of EEEs 16-33, wherein the body-mountable device is configured to be worn on a user's wrist or chest.

EEE 35 is the system as in any of EEEs 16-34, wherein the body-mountable device is coupled to at least one of a protective glove or a head-mountable display (HMD).

EEE 36 is a method comprising:
receiving, from at least one sensor disposed in proximity to an abrasive product, at least one of vibration or noise information associated with the abrasive product, wherein the at least one sensor is configured to detect vibration and noise;
determining product-specific information based on the at least one of the vibration or noise information; and
transmitting, to a remote computing device via a communication interface, the product-specific information.

EEE 37 is the method of EEE 36, wherein the product-specific information comprises at least one of: an operational status, an operational duration, an idle duration, or a productive time for the abrasive product.

EEE 38 is the method as in any of EEEs 36-37, wherein the product-specific information comprises information indicative of an abrasion operation associated with the abrasive product.

EEE 39 is the method as in any of EEEs 36-38, wherein determining the product-specific information based on the at least one of the vibration or noise information comprises comparing the at least one of the vibration or noise information with a set of at least one of known vibration or noise patterns.

EEE 40 is the method as in any of EEEs 36-39, further comprising determining the abrasive product based on an identification process.

EEE 41 is the method as in any of EEEs 36-40, wherein the identification process comprises at least one of: a user input, a remote handshake communication process, a proximity detection process, or an optical recognition process.

EEE 42 is the method as in any of EEEs 36-41, wherein the product-specific information determined based on the at least one of the vibration or noise information comprises real-time abrasion information about the abrasion product.

EEE 43 is the method as in any of EEEs 36-42, wherein transmitting the product-specific information comprises transmitting the product-specific information to a cloud computing platform.

EEE 44 is the method as in any of EEEs 36-43, further comprising:
in response to determining the product-specific information, transmitting at least one control instruction to the abrasive product.

EEE 45 is the method as in any of EEEs 36-44, wherein the at least one control instruction comprises at least one of: adjust a rotational speed, provide a notification, turn on tool, or turn off tool.

EEE 46 is the method as in any of EEEs 36-45, wherein the at least one control instruction is received from a remote controlled switch.

EEE 47 is a system comprising:
a body-mountable device comprising:
at least one sensor, wherein the at least one sensor is configured to detect vibration data associated with a specific abrasion tool or a specific abrasive product; and
a controller comprising a memory and a processor, wherein the memory stores instructions that are executable by the processor to cause the controller to perform operations, the operations comprising:
generating a vibration signal based on a frequency analysis on the vibration data;
generating, using the vibration signal, an angular velocity (RPM) signal; and
determining, based on the vibration signal and the RPM signal, product-specific information.

EEE 48 is the system of EEE 47, wherein generating the RPM signal comprises performing a Fourier transform analysis on the vibration signal.

EEE 49 is the system as in any of EEEs 47-48, wherein the product-specific information is based, at least in part, on the length of time the vibration signal or the RPM signal falls below an upper limit and above a lower limit.

EEE 50 is the system of EEE 49, wherein the upper limit and the lower limit are based on ISO 5349 standards.

EEE 51 is a system comprising:
an abrasive tool configured to perform abrasive operations using an abrasive article;
an auxiliary component attached to the surface of the abrasive tool, wherein the auxiliary component has greater degrees of freedom than the abrasive tool;
at least one sensor, wherein the at least one sensor is configured to detect vibration data associated with operation of the abrasive tool, wherein the at least one sensor is mounted on the auxiliary component; and
a controller comprising a memory and a processor, wherein the memory stores instructions that are executable by the processor to cause the controller to perform operations, the operations comprising:
generating a vibration signal based on the vibration data;
converting the vibration signal into an angular velocity (RPM) signal,
determining, based on the vibration signal and the RPM signal, product-specific information related to the abrasive tool.

EEE 52 is a system comprising:
persistent storage containing: (i) a first set of mappings between plants and abrasive tools respectively operating within the plants, (ii) a second set of mappings between the abrasive tools and body-mountable devices respectively associated with the abrasive tools, and (iii) a third set of mappings between the body-mountable devices and operators respectively associated with the body-mountable devices; and
one or more processors configured to perform operations comprising:
receiving, from a client device, a request to view abrasive operation metrics associated with at least one plant from the plants;
determining, based on the first set of mappings, a set of tools associated with the at least one plant;
receiving, from the client device, a request to view abrasive operation metrics associated with at least one tool from the set of tools;
determining, based on the second set of mappings, a set of body-mountable devices associated with the at least one tool;
determining, based on the third set of mapping, a set of operators associated with the set of body-mountable devices; and
providing, to the client device, abrasive operation metrics related to the set of operators.

EEE 53 is the system EEE 52, wherein the operations further comprise:
receiving, from the client device, a request to view abrasive operation metrics within a date range, wherein providing the abrasive operation metrics comprises providing the abrasive operation metrics within the date range.

We claim:

1. A system comprising:
a body-mountable device comprising:
at least one sensor, wherein the at least one sensor is configured to detect abrasive operational data associated with an abrasive operation involving an abrasive product or a workpiece;
a communication interface; and
a controller comprising a memory and a processor, wherein the memory stores instructions that are executable by the processor to cause the controller to perform operations, the operations comprising:
receiving, from the at least one sensor, the abrasive operational data;
determining, based on the abrasive operational data, product-specific information of the abrasive product or workpiece-specific information of the workpiece; and
transmitting, via the communication interface, the product-specific information or workpiece-specific information; and
a remote computing device configured to receive the transmitted product-specific information or workpiece-specific information.

2. The system of claim 1, wherein the body-mountable device is configured to be worn on a user's wrist or chest.

3. The system of claim 1, wherein the body-mountable device is coupled to at least one of a protective glove or a head-mountable display (HMD).

4. The system of claim 1, wherein the operations further comprise:
using the communication interface to receive an identifier of the abrasive product from the remote computing device; and
identifying the abrasive product using the identifier.

5. The system of claim 4, wherein the communication interface comprises at least one of: an image capture device, a wireless communication device, a near-field communication (NFC) device, a radio frequency identification (RFID) reader, a Bluetooth device, or a LoRa (low-power wide-area network) device.

6. The system of claim 1, wherein the abrasive operational data comprises at least one of vibration or noise data, and wherein determining the product-specific information or the workpiece-specific information is further based on the at least one of vibration or noise data.

7. The system of claim 6, wherein the at least one of vibration or noise data is sampled, by the at least one sensor, at a sampling rate, wherein the sampling rate is selected based on at least one of a data resolution or an available energy level of a battery of the at least one sensor.

8. The system of claim 6, wherein the operations further comprise providing at least one of the vibration or noise data to the remote computing device, wherein the remote computing device is further configured to analyze at least one of received vibration or noise data

9. The system of claim 6, wherein determining the product-specific information or the workpiece-specific information based on the at least one of the vibration or noise data comprises comparing the at least one of the vibration or noise data with a set of at least one of known vibration or noise patterns.

10. The system of claim 6, wherein the operations further comprise:
performing a frequency analysis on the vibration data to generate a corresponding vibration signal; and
determining an angular velocity (RPM) signal associated with the vibration signal, wherein determining the product-specific information or the workpiece-specific information is further based on the vibration signal or the RPM signal.

11. The system of claim 10, wherein determining the RPM signal associated with the vibration signal comprises performing a Fourier transform analysis on the vibration signal.

12. The system of claim 10, wherein the product-specific information or the workpiece-specific information is based, at least in part, on a length of time the vibration signal or the RPM signal falls below an upper limit and above a lower limit.

13. The system of claim 12, wherein the upper limit and the lower limit are based on ISO 5349 standards.

14. The system of claim 1, wherein the product-specific information comprises at least one of: an operational status, an operational duration, an idle duration, a productive time for the abrasive product, or information indicative of an abrasion operation associated with the abrasive product.

15. The system of claim 1, wherein the at least one sensor is disposed within the abrasive product or remotely from the abrasive product.

16. A method comprising:
receiving, at a body-mountable device, from at least one sensor disposed in proximity to an abrasive product or a workpiece, abrasive operational data associated with an abrasive operation involving the abrasive product or the workpiece;
determining, by the body-mountable device, product-specific information or workpiece-specific information based on the abrasive operational data; and
transmitting, by the body-mountable device, to a remote computing device via a communication interface, the product-specific information or the workpiece-specific information.

17. The method of claim 16, further comprising:
in response to determining the product-specific information or the workpiece-specific information, transmitting at least one control instruction to the abrasive product.

18. The method of claim 17, wherein the at least one control instruction comprises at least one of: adjust a rotational speed, provide a notification, turn on tool, or turn off tool.

19. The method of claim 16, further comprising:
determining, at the remote computing device, a particular abrasive product or a particular workpiece associated with the product-specific information or the workpiece-specific information, wherein the remote computing device includes a trained machine learning system configured to infer particular workpieces or particular abrasive products based on product-specific information or workpiece-specific information.

20. A system including:
a database containing mappings between: (i) prior abrasive operational data involving abrasive products and workpieces; and (ii) product-specific information and workpiece specific-information associated with the prior abrasive operational data; and
a computing device configured to perform operations, the operations comprising:
receiving, from at least one sensor is configured to detect abrasive operational data, abrasive operational data associated with an abrasive operation involving an abrasive product and a workpiece; and
predicting, using the mappings, that the abrasive operational data relates to product-specific information of the abrasive product or workpiece-specific information of the workpiece

21. The system of claim 20, wherein the database further contains: (i) a first set of mappings between plants and abrasive products respectively operating within the plants, (ii) a second set of mappings between the abrasive products and body-mountable devices respectively associated with the abrasive products, and (iii) a third set of mappings between the body-mountable devices and operators respectively associated with the body-mountable devices, and wherein the operations further comprise:
receiving, from a client device, a request to view abrasive operational data associated with at least one plant from the plants;
determining, based on the first set of mappings, a set of abrasive products associated with the at least one plant;
receiving, from the client device, a request to view abrasive operational data associated with at least one abrasive product from the set of abrasive products;
determining, based on the second set of mappings, a set of body-mountable devices associated with the at least one abrasive product;
determining, based on the third set of mappings, a set of operators associated with the set of body-mountable devices; and
providing, to the client device, abrasive operational data related to the set of operators.

22. The system of claim 21, wherein the operations further comprise:
receiving, from the client device, a request to view abrasive operational data within a date range, wherein providing the abrasive operational data comprises providing the abrasive operational data within the date range.
